(19) United States
(12) Patent Application Publication
(10) Pub. No.: US 2022/0041856 A1
(43) Pub. Date: Feb. 10, 2022

(54) EPOXY RESIN COMPOSITION, CURABLE RESIN COMPOSITION, CURED PRODUCT, AND ADHESIVE

(71) Applicant: Mitsubishi Chemical Corporation, Tokyo (JP)

(72) Inventors: Hiroshi ONOMOTO, Tokyo (JP); Kazuyoshi ODAKA, Tokyo (JP); Go OTANI, Tokyo (JP); Iho KAMIMURA, Tokyo (JP)

(73) Assignee: Mitsubishi Chemical Corporation, Tokyo (JP)

(21) Appl. No.: 17/450,841

(22) Filed: Oct. 14, 2021

Related U.S. Application Data
(63) Continuation of application No. PCT/JP2020/016566, filed on Apr. 15, 2020.

(30) Foreign Application Priority Data
Apr. 19, 2019 (JP) 2019-080298

(51) Int. Cl. C08L 63/00; C08F 283/12; C08F 236/06; C08F 212/08; C08L 51/04; C08G 59/40; C08G 59/24; C08F 220/14; C08F 220/32; C08F 222/10; C08F 2/38; C08F 2/22

(52) U.S. Cl. CPC C08L 63/00; C08G 2170/00; C08F 236/06; C08F 212/08; C08L 51/04; C08G 59/4021; C08G 59/245; C08F 220/14; C08F 220/325; C08F 222/102; C08F 2/38; C08F 2/22; C08L 2205/03; C08L 2207/53; C08L 2205/22; C08F 283/12

(57) ABSTRACT

These vinyl-based polymerizable group-containing silane compounds may be used alone, or two or more thereof may be used in combination. The content of the vinyl-based polymerizable group-containing silane compound is 1% by mass or more and 10% by mass or less, and preferably 1% by mass or more and 5% by mass or less, in 100% by mass of the organosiloxane mixture. When the amount of the vinyl-based polymerizable group-containing silane compound is the lower limit value or more, the peeling force and impact resistance of the obtained cured product tend to be high. When the amount of the vinyl-based polymerizable group-containing silane compound is the upper limit value or less, the peeling force and impact resistance of the obtained cured product tend to be high.

The present application is a continuation application of International Application No. PCT/JP2020/016566, filed Apr. 15, 2020, which claims priority of Japanese Patent Application No. 2019-080298, filed Apr. 19, 2019, the content of which is incorporated herein by reference.

### TECHNICAL FIELD

The present invention relates to an epoxy resin composition, a curable resin composition, a cured product, and an adhesive.

### BACKGROUND ART

A cured product of an epoxy resin has excellent heat resistance, electrical properties, durability and the like. Therefore, an epoxy resin composition comprising an epoxy resin and a curing agent thereof can be used for various applications such as adhesives for vehicle structures, adhesives for civil engineering and construction, adhesives for electronic materials, industrial adhesives, and molding materials.

Since the cured product of an epoxy resin is brittle, there is a problem in that the impact resistance and the adhesive strength are inferior. Therefore, conventionally, in order to impart toughness to a cured product, a thermoplastic resin, a rubber component, or the like is blended with the epoxy resin composition.

Patent Literature 1 discloses a rubber-containing polymer suitable for an epoxy resin.

Patent Literature 2 discloses a polymer obtained by polymerizing a polyfunctional monomer as another vinyl monomer in a method of adding a rubber-containing polymer to an epoxy resin.

### CITATION LIST

### Patent Literature

### [Patent Literature 1]

PCT International Publication No. WO2004/108825

### [Patent Literature 2]

PCT International Publication No. WO2015/53289

### SUMMARY OF INVENTION

### Technical Problem

However, since the rubber-containing polymer of Patent Literature 1 does not have a cross-linked structure, blocking occurs between the particles of the rubber-containing polymer during the process of producing an epoxy resin containing a rubber-containing polymer, and there is a problem in that dispersibility in the epoxy resin is likely to deteriorate.

Since the rubber-containing polymer of Patent Literature 2 has a low glass transition point in an outermost layer, blocking occurs between the particles of the rubber-containing polymer during the process of producing an epoxy resin that contains a rubber-containing polymer, and there is a problem in that dispersibility in the epoxy resin is likely to deteriorate.

When the dispersibility of the rubber-containing polymer in the epoxy resin deteriorates, the impact resistance of the obtained cured product deteriorates.

An object of the present invention is to provide: an epoxy resin composition and a curable resin composition that provide a cured product in which a rubber-containing polymer is well dispersed in epoxy resin and which has excellent impact resistance; and a cured product of the epoxy resin composition and a cured product of the curable resin composition.

### Solution to Problem

The present invention has the following aspects.

[1] An epoxy resin composition, comprising: a rubber-containing polymer and an epoxy resin, in which the rubber-containing polymer contains at least one rubbery polymer and at least one vinyl monomer part, and the vinyl monomer part has a unit based on a monomer (a) described below, a unit based on a monomer (b) described below, and a unit based on a monomer (c) described below, wherein the monomer (a) is a polyfunctional (meth)acrylate, the monomer (b) is at least one monomer selected from a group consisting of epoxy group-containing (meth)acrylates and aromatic vinyl monomers, and the monomer (c) is an alkyl (meth)acrylate.

[2] The epoxy resin composition according to [1], in which the rubbery polymer is at least one selected from a group consisting of a diene rubber, a diene-acrylic composite rubber, an acrylic rubber, a silicone rubber, and an acrylic-silicone composite rubber.

[3] The epoxy resin composition according to [1] or [2], in which a proportion of the unit based on the monomer (a) is 1% by mass or more and 45% by mass or less, and a proportion of the unit based on the monomer (b) is 1% by mass or more and 50% by mass or less, with respect to a total mass of the vinyl monomer part.

[4] A curable resin composition, comprising: a rubber-containing polymer, an epoxy resin, and a curing agent, in which the rubber-containing polymer contains at least one rubbery polymer and at least one vinyl monomer part, and the vinyl monomer part has a unit based on a monomer (a) described below, a unit based on a monomer (b) described below, and a unit based on a monomer (c) described below, wherein the monomer (a) is a polyfunctional (meth)acrylate, the monomer (b) is at least one monomer selected from a group consisting of epoxy group-containing (meth)acrylates and aromatic vinyl monomers, and the monomer (c) is an alkyl (meth)acrylate.

[5] The curable resin composition according to [4], in which the rubbery polymer is at least one selected from a group consisting of a diene rubber, a diene-acrylic composite rubber, an acrylic rubber, a silicone rubber, and an acrylic-silicone composite rubber.

[6] The curable resin composition according to [4] or [5], in which a proportion of the unit based on the monomer (a) is 1% by mass or more and 45% by mass or less, and a proportion of the unit based on the monomer (b) is 1% by mass or more and 50% by mass or less, with respect to a total mass of the vinyl monomer part.

[7] A cured product of the curable resin composition according to any one of [4] to [6].

[8] An epoxy resin composition, comprising: a rubber-containing polymer, an epoxy resin, and a (meth)acrylic copolymer, in which the (meth)acrylic copolymer has a constituting unit derived from a macromonomer (d) and a constituting unit derived from a vinyl monomer (e), a glass transition temperature (TgE) of a polymer obtained by polymerizing only the vinyl monomer (e) is 25 degrees or less, the rubber-containing polymer contains at least one rubbery polymer and at least one vinyl monomer part, and the vinyl monomer part has a unit based on a monomer (a) described below, a unit based on a monomer (b) described below, and a unit based on a monomer (c) described below, wherein the monomer (a) is a polyfunctional (meth)acrylate, the monomer (b) is at least one monomer selected from a group consisting of epoxy group-containing (meth)acrylates and aromatic vinyl monomers, and the monomer (c) is an alkyl (meth)acrylate.

[9] The epoxy resin composition according to [8], in which a number-average molecular weight of the macromonomer (d) is 500 or more and 100,000 or less.

[10] The epoxy resin composition according to [8] or [9], in which the content of the constituting unit derived from the macromonomer (d) in the (meth)acrylic copolymer is 10% by mass or more and 90% by mass or less with respect to the total mass of all the constituting units of the (meth)acrylic copolymer.

[11] The epoxy resin composition according to any one of [8] to [10], in which the macromonomer (d) has a radically polymerizable group and has two or more constituting units represented by Formula (da) described below.

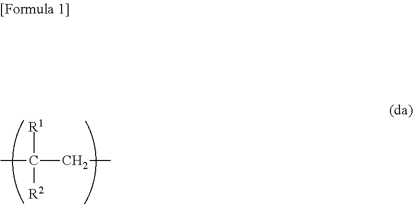

In the formula, R¹ represents a hydrogen atom, a methyl group, or CH₂OH, R² represents OR³, a halogen atom, COR⁴, COOR⁵, CN, CONR⁶R⁷, NHCOR⁸, or R⁹. R³ to R⁸ independently represent a hydrogen atom, a substituted or unsubstituted alkyl group, a substituted or unsubstituted alicyclic group, a substituted or unsubstituted aryl group, a substituted or unsubstituted heteroaryl group, a substituted or unsubstituted non-aromatic heterocyclic group, a substituted or unsubstituted aralkyl group, a substituted or unsubstituted alkaryl group, a substituted or unsubstituted organosilyl group, or a substituted or unsubstituted (poly)organosiloxane group. The substituents that substitute these groups are at least one selected from a group consisting of an alkyl group, an aryl group, a heteroaryl group, a non-aromatic heterocyclic group, an aralkyl group, an alkaryl group, a carboxylic acid group, a carboxylic acid ester group, an epoxy group, a hydroxy group, an alkoxy group, a primary amino group, a secondary amino group, a tertiary amino group, an isocyanato group, a sulfonic acid group, and a halogen atom. R⁹ represents a substituted or unsubstituted aryl group, a substituted or unsubstituted heteroaryl group or a substituted or unsubstituted non-aromatic heterocyclic group. The substituents that substitute these groups are at least one selected from a group consisting of an alkyl group, an aryl group, a heteroaryl group, a non-aromatic heterocyclic group, an aralkyl group, an alkaryl group, a carboxylic acid group, a carboxylic acid ester group, an epoxy group, a hydroxy group, an alkoxy group, a primary amino group, a secondary amino group, a tertiary amino group, an isocyanato group, a sulfonic acid group, a substituted or unsubstituted olefin group, and a halogen atom.

[12] The epoxy resin composition according to [11], in which the macromonomer (d) is a macromonomer represented by Formula (1) described below.

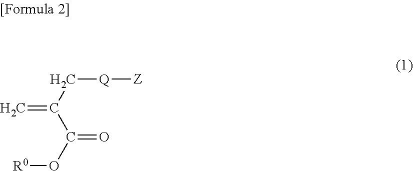

In the formula, R⁰ represents a hydrogen atom, a substituted or unsubstituted alkyl group, a substituted or unsubstituted alicyclic group, a substituted or unsubstituted aryl group, a substituted or unsubstituted heteroaryl group, a substituted or unsubstituted non-aromatic heterocyclic group, a substituted or unsubstituted aralkyl group, a substituted or unsubstituted alkaryl group, a substituted or unsubstituted organosilyl group, or a substituted or unsubstituted (poly)organosiloxane group, Q represents a main chain part including two or more constituting units represented by the above-described Formula (da), and Z represents an end group.

[13] The epoxy resin composition according to any one of [8] to [12], in which the macromonomer (d) contains a constituting unit having a cyclic ether group.

[14] The epoxy resin composition according to [13], in which the constituting unit having a cyclic ether group is contained in an amount of 10% by mass or more and 100% by mass or less with respect to the total mass of the constituting unit derived from the macromonomer (d).

[15] The epoxy resin composition according to [13] or [14], in which the number of contained cyclic ether groups derived from the macromonomer (d) is 0.001×10⁻³ or more and 90.0×10⁻³ or less with respect to a total mass of 100 parts by mass of the rubber-containing polymer and the (meth)acrylic copolymer.

[16] The epoxy resin composition according to any one of [13] to [15], in which the cyclic ether group derived from the macromonomer (d) is one or more selected from a group consisting of an oxiranyl group, an oxetanyl group, an oxolanyl group, a dioxolanyl group, and a dioxanyl group.

[17] The epoxy resin composition according to any one of [8] to [16], in which the macromonomer (d) has a constituting unit derived from one or more monomers selected from a group consisting of glycidyl (meth)acrylate, (3,4-epoxycyclohexyl)methyl (meth)acrylyate, β-methylglycidyl (meth)acrylate, (3-ethyloxetan-3-yl)methyl (meth)acrylate, tetrahydrofurfuryl (meth)acrylate, (2-methyl-2-ethyl-1,3-dioxolan-4-yl) (meth)acrylate, and (5-ethyl-1,3-dioxane-5-yl)methyl (meth)acrylate.

[18] The epoxy resin composition according to any one of [8] to [17], in which the rubbery polymer is at least one selected from a group consisting of a diene rubber, a diene-acrylic composite rubber, an acrylic rubber, a silicone rubber, and an acrylic-silicone composite rubber.

[19] The epoxy resin composition according to any one of [8] or [18], in which a proportion of the unit based on the monomer (a) is 1% by mass or more and 45% by mass or less, and a proportion of the unit based on the monomer (b) is 1% by mass or more and 50% by mass or less, with respect to a total mass of the vinyl monomer part.

[20] A curable resin composition, comprising: the epoxy resin composition according to any one of [8] to [19]; and a curing agent.

[21] An adhesive, comprising: the epoxy resin composition according to any one of [8] to [19] or the curable resin composition according to [20].

[22] A molding material, comprising: the epoxy resin composition according to any one of [8] to [19] or the curable resin composition according to [20].

[23] A cured product, comprising: the epoxy resin composition according to any one of [8] to [19] or the curable resin composition according to [20].

### Advantageous Effects of Invention

According to the epoxy resin composition and the curable resin composition of the present invention, the rubber-containing polymer is well dispersed in the epoxy resin, and a cured product having excellent impact resistance can be obtained.

In the cured product of the present invention, the rubber-containing polymer is well dispersed in the epoxy resin and the cured product has excellent impact resistance.

### DESCRIPTION OF EMBODIMENTS

In the present invention, the vinyl monomer is a compound having a polymerizable double bond.

The “(meth)acrylate” is an acrylate or a methacrylate.

The “polyfunctional (meth)acrylate” is a (meth)acrylate having two or more (meth)acryloyl groups.

The “macromonomer (d)” means a polymer monomer having a radically polymerizable functional group or an addition-reactive functional group. It is preferable to have a functional group at the end. The molecular weight is usually 1000 or more and one million or less.

The “vinyl monomer (e)” means a monomer that is not a macromonomer (d) and has an ethylenically unsaturated bond.

The “(meth)acrylic copolymer” means a copolymer in which at least some of the constituting units are a constituting unit derived from a (meth)acrylic monomer. The (meth)acrylic polymer may further contain a constituting unit derived from a monomer (for example, styrene) other than a (meth)acrylic monomer.

The “(meth)acrylic monomer” means a monomer having a (meth)acryloyl group.

The “block copolymer” means a copolymer having a plurality of blocks in the polymer and adjacent blocks having different structures (chemical structures). For example, adjacent blocks consist of constituting units derived from different monomers.

“to” indicating a numerical range means that the numerical values stated before and after “to” are included as a lower limit value and an upper limit value.

### <Epoxy Resin Composition>

The epoxy resin composition of the present invention contains a rubber-containing polymer and an epoxy resin.

The epoxy resin composition of the present invention may further contain a (meth)acrylic copolymer, when necessary.

The epoxy resin composition of the present invention does not contain a curing agent.

The epoxy resin composition of the present invention may further contain a curing accelerator, when necessary.

The epoxy resin composition of the present invention may further contain components other than the rubber-containing polymer, the epoxy resin, the (meth)acrylic copolymer, the curing agent, and the curing accelerator, when necessary.

### (Rubber-Containing Polymer)

The rubber-containing polymer contains at least one rubbery polymer and at least one vinyl monomer part. The vinyl monomer part has a unit based on the following monomer (a), a unit based on the following monomer (b), and a unit based on the following monomer (c). The rubbery polymer and the vinyl monomer part will be described in detail later.

The proportion of the rubbery polymer in 100% by mass of the rubber-containing polymer is preferably 60% by mass or more and 95% by mass or less, more preferably 70% by mass or more and 90% by mass or less, and still more preferably 75% by mass or more and 85% by mass or less. When the proportion of the rubbery polymer is 60% by mass or more, the impact resistance of the cured product is further improved. When the proportion of the rubbery polymer is 90% by mass or less, the dispersibility of the rubber-containing graft polymer in the epoxy resin is superior.

The volume-average particle size of the rubber-containing polymer is preferably 0.05 μm or more and 1 μm or less, more preferably 0.1 μm or more and 0.5 μm or less, still more preferably 0.1 μm or more and 0.35 μm or less, and particularly preferably 0.1 μm or more and 0.25 μm or less. When the volume-average particle size is within the above-described range, the impact resistance-improving effect when the rubber-containing polymer is blended with the epoxy resin is further improved.

The volume-average particle size of the rubber-containing polymer is measured by a laser diffraction and scattering method in a state of a latex in which the rubber-containing polymer is dispersed in water.

### [Rubbery Polymer]

Examples of the rubbery polymer include a diene rubber, a diene-acrylic composite rubber, an acrylic rubber, a silicone rubber, an acrylic-silicone composite rubber, an isobutylene-silicone composite rubber, a styrene-butadiene rubber, an ethylene-propylene rubber, a nitrile rubber, and an ethylene-acrylic rubber. One of these may be used alone, or two or more thereof may be used in combination.

As the rubbery polymer, from the viewpoint of an impact resistance-improving effect when the rubber-containing polymer is blended with the epoxy resin, a diene rubber, a diene-acrylic composite rubber, an acrylic rubber, a silicone rubber, and an acrylic-silicone composite rubber are preferable, a diene rubber, a silicone rubber, and an acrylic-silicone composite rubber are more preferable, a diene rubber and an acrylic-silicone composite rubber are still more preferable, and a diene rubber is particularly preferable.

### [Diene Rubber]

The diene rubber is obtained by (co)polymerizing a diene monomer and, when necessary, a vinyl monomer which is copolymerizable with the diene monomer.

Examples of the diene monomer include butadiene, isoprene, and chloroprene. Of these, butadiene is preferable from the viewpoint of an impact resistance-improving effect when the rubber-containing polymer is blended with the epoxy resin.

Examples of the vinyl monomer which is copolymerizable with the diene monomer include monofunctional monomers such as styrene, ethylene, acrylonitrile, and alkyl (meth)acrylates; and polyfunctional monomers such as divinylbenzene, ethylene glycol dimethacrylate, butylene glycol diacrylate, triallyl cyanurate, triallyl isocyanurate, trimethylolpropane triacrylate, and pentaerythritol tetraacrylate. One of these may be used alone, or two or more thereof may be used in combination.

When a diene rubbery polymer is used, from the viewpoint of an impact resistance-improving effect when the rubber-containing polymer is blended with the epoxy resin, the proportion of the unit based on the diene monomer in 100% by mass is preferably 50% by mass or more, more preferably 70% by mass or more, and still more preferably 80% by mass or more, and particularly preferably 90% by mass or more. The upper limit of the proportion of the unit based on the diene monomer in 100% by mass is not particularly limited, and may be 100% by mass.

### [Silicone Rubber and Acrylic-Silicone Composite Rubber]

As the silicone rubber and the acrylic-silicone composite rubber, a composite rubber containing a silicone rubber, a polyorganosiloxane, and polyalkyl (meth)acrylate are preferable.

The polyorganosiloxane is a polymer containing an organosiloxane unit as a constituting unit. The polyorganosiloxane can be obtained by polymerizing an organosiloxane mixture containing an “organosiloxane”, a “vinyl-based polymerizable group-containing silane compound”, and components used as necessary. Examples of the component used as necessary include a siloxane-based cross-linking agent; and a siloxane oligomer having an end blocking group.

As the organosiloxane, either a chain organosiloxane or a cyclic organosiloxane can be used. A cyclic organosiloxane is preferable because of its high polymerization stability and a high polymerization rate. The cyclic organosiloxane preferably has 3 or more ring members and 7 or less ring members. Examples thereof include hexamethylcyclotrisiloxane, octamethylcyclotetrasiloxane, decamethylcyclopentasiloxane, dodecamethylcyclohexasiloxane, trimethyltriphenylcyclotrisiloxane, tetramethyltetraphenylcyclotetrasiloxane, and octaphenylcyclotetrasiloxane. One of these may be used alone, or two or more thereof may be used in combination. Of these, since it is then easy to control the particle size distribution of the rubber containing polyorganosiloxane, it is preferable that 60% by mass or more of the total amount of the organosiloxane mixture be octamethylcyclotetrasiloxane.

The vinyl-based polymerizable group-containing silane compound is used as a siloxane-based graft crossing agent. The vinyl-based polymerizable group-containing silane compound has a siloxy group and a functional group which is copolymerizable with the vinyl monomer. By using the vinyl-based polymerizable group-containing silane compound, a polyorganosiloxane having a functional group which is copolymerizable with a vinyl monomer can be obtained. By using such a graft crossing agent, an alkyl (meth)acrylate component for composite rubber or a vinyl monomer, which will be described later, can be grafted onto a polyorganosiloxane by radical polymerization.

Examples of the vinyl-based polymerizable group-containing silane compound include siloxanes represented by Formula (2).

[Formula 3]

R²⁰SiR²¹ₚ(OR²²)₃₋ₚ (2)

In the formula, R²¹ represents a methyl group, an ethyl group, a propyl group, or a phenyl group. R²² represents an organic group in the alkoxyl group, and examples thereof include a methyl group, an ethyl group, a propyl group, and a phenyl group. p represents 0, 1, or 2. R²⁰ represents any group represented by the following Formulas (3) to (6).

[Formula 4]

CH₂═C(R²³)—COO—(CH₂)_{q}— (3)

CH₂═C(R²⁴)—C₆H₄— (4)

CH₂═CH— (5)

HS—(CH₂)_{q}— (6)

In these formulas, R²³ and R²⁴ represent hydrogen or methyl groups, and q represents an integer from 1 to 6.

Examples of the functional group represented by Formula (3) include a methacryloyloxyalkyl group. Examples of the siloxane having a methacryloyloxyalkyl group include β-methacryloyloxyethyl dimethoxymethylsilane, γ-methacryloyloxypropylmethoxydimethylsilane, γ-methacryloyloxypropyldimethoxymethylsilane, γ-methacryloyloxypropyltrimethoxysilane, γ-methacryloyloxypropylethoxydiethylsilane, γ-methacryloyloxypropyldiethoxymethylsilane, and 6-methacryloyloxybutyldiethoxymethylsilane.

Examples of the functional group represented by Formula (4) include a vinylphenyl group and the like. Examples of the siloxane having a vinylphenyl group include vinylphenylethyldimethoxysilane.

Examples of the siloxane having a functional group represented by Formula (5) include vinyltrimethoxysilane and vinyltriethoxysilane.

Examples of the functional group represented by Formula (6) include a mercapto alkyl group. Examples of the siloxane having a mercapto alkyl group include γ-mercaptopropyldimethoxymethylsilane, γ-mercaptopropylmethoxydimethylsilane, γ-mercaptopropyldiethoxymethylsilane, γ-mercaptopropylethoxydimethylsilane, and γ-mercaptopropyltrimethoxysilane.

Among these, a vinyl-based polymerizable group-containing silane compound having a functional group represented by Formula (3), a vinyl-based polymerizable group-containing silane compound having a functional group represented by Formula (5), and a vinyl-based polymerizable group-containing silane compound having a functional group represented by Formula (6) are preferable from an economic point of view, and a vinyl-based polymerizable group-containing silane compound having a functional group represented by Formula (3) is more preferable.

These vinyl-based polymerizable group-containing silane compounds may be used alone, or two or more thereof may be used in combination. The content of the vinyl-based polymerizable group-containing silane compound is 1% by mass or more and 10% by mass or less, and preferably 1% by mass or more and 5% by mass or less, in 100% by mass of the organosiloxane mixture. When the amount of the vinyl-based polymerizable group-containing silane compound is the lower limit value or more, the peeling force and impact resistance of the obtained cured product tend to be high. When the amount of the vinyl-based polymerizable group-containing silane compound is the lower limit value or less, the peeling force and impact resistance of the obtained cured product tend to be high.

The siloxane-based cross-linking agent preferably has a siloxy group. By using a siloxane-based cross-linking agent, a polyorganosiloxane having a cross-linked structure can be obtained. Examples of the siloxane-based cross-linking agent include trifunctional or tetrafunctional cross-linking agents such as trimethoxymethylsilane, triethoxyphenylsilane, tetramethoxysilane, tetraethoxysilane, tetra-n-propoxysilane, and tetrabutoxysilane. Of these, a tetrafunctional cross-linking agent is preferable, and tetraethoxysilane is more preferable.

The content of the siloxane-based cross-linking agent is preferably 0% by mass or more and 30% by mass or less, more preferably 0.1% by mass or more and 30% by mass or less, still more preferably 0.1% by mass or more and 10% by mass or less, particularly preferably 0.1% by mass or more and 1.8% by mass or less, and most preferably 0.1% by mass or more and 1.6% by mass or less, in 100% by mass of the organosiloxane mixture.

The siloxane oligomer having an end blocking group means a siloxane oligomer that has an alkyl group or the like at the end of the organosiloxane oligomer and stops the polymerization of the polyorganosiloxane. Examples of the siloxane oligomer having an end blocking group include hexamethyldisiloxane, 1,3-bis(3-glycidoxypropyl)tetramethyldisiloxane, 1,3-bis(3-aminopropyl)tetramethyldisiloxane, and methoxytrimethylsilane.

The glass transition temperature of the rubbery polymer is preferably −10° C. or lower, more preferably −30° C. or lower, and still more preferably −70° C. or lower from the viewpoint of an impact resistance-improving effect when the rubber-containing polymer is blended with the epoxy resin. The lower limit of the glass transition temperature is not particularly limited, but is, for example, −120° C.

The glass transition temperature of the rubbery polymer is obtained by dynamic viscoelasticity measurement.

The rubbery polymer can be produced by polymerizing the monomers that constitute the rubbery polymer.

The polymerization method for producing a rubbery polymer is not particularly limited, but examples thereof include bulk polymerization, emulsion polymerization, suspension polymerization, and solution polymerization. Of these, emulsion polymerization is preferable from the viewpoint that it is then easy to control the particle size of the rubbery polymer and it is easy to obtain a rubber-containing polymer having a core-shell structure.

The polymerization initiator used for the polymerization is not particularly limited, and a known polymerization initiator can be used. Examples thereof include persulfates; organic peroxides; an azo-based initiator; a redox-based initiator in which a persulfate and a reducing agent are combined; and a redox-based initiator in which an organic peroxide and a reducing agent are combined. These polymerization initiators may be used alone, or two or more thereof may be used in combination.

The amount of the polymerization initiator used is preferably 0.05 parts by mass or more and 1.0 parts by mass or less, and more preferably 0.1 parts by mass or more and 0.3 parts by mass or less, with respect to 100 parts by mass of the total amount of the monomers.

The emulsifier used for emulsion polymerization is not particularly limited, and a known emulsifier can be used. Examples thereof include anionic surfactants such as fatty acid salts, alkyl sulfate ester salts, alkylbenzene sulfonates, alkyl phosphate ester salts, and dialkyl sulfosuccinates; nonionic surfactant such as polyoxyethylene alkyl ethers, polyoxyethylene fatty acid esters, sorbitan fatty acid esters, and glycerine fatty acid esters; and cationic surfactant such as alkylamine salts. These emulsifiers may be used alone, or two or more thereof may be used in combination.

The amount of the emulsifier used is not particularly limited, but is preferably 0.1 parts by mass or more and 10 parts by mass or less, and more preferably 0.1 parts by mass or more and 5 parts by mass or less, with respect to 100 parts by mass of the resin solid content in the rubbery polymer latex. When the amount of the emulsifier used is 0.1 parts by mass or more, the emulsion stability is excellent, and when the amount is 10 parts by mass or less, the latex of the rubber-containing polymer is easily coagulated.

### (Vinyl Monomer Part)

A rubber-containing polymer can be obtained by polymerizing the vinyl monomer in the presence of the rubbery polymer. The polymer part consisting of units based on this vinyl monomer is called a vinyl monomer part.

The vinyl monomer part has a unit based on the monomer (a), a unit based on the monomer (b), and a unit based on the monomer (c), as units based on a vinyl monomer.

The vinyl monomer part may further have a unit based on a monomer other than the monomers (a) to (c), when necessary.

[Monomer (a)]

The monomer (a) is a polyfunctional (meth)acrylate.

Since the vinyl monomer part contains the unit based on the monomer (a), a cross-linked structure is formed in the vinyl monomer part, the particles of the rubber-containing polymer do not aggregate and are well dispersed in the epoxy resin when blended with the epoxy resin, and thus, the impact resistance is improved.

The polyfunctional (meth)acrylate is not particularly limited as long as the polyfunctional (meth)acrylate is a bifunctional or higher (meth)acrylate having two or more (meth)acryloyl groups. Examples of the polyfunctional (meth)acrylate include ethylene glycol di(meth)acrylate, 1,3-butylene glycol di(meth)acrylate, 1,6-hexanediol di(meth)acrylate, 1,7-heptanediol di(meth)acrylate, 1,8-octanediol di(meth)acrylate, 1,9-nonanediol di(meth)acrylate, 1,10-decanediol di(meth)acrylate, 1,12-dodecanediol di(meth)acrylate, 1,16-hexadecanediol di(meth)acrylate, batyl alcohol di(meth)acrylate, 3-methyl 1,5-pentanediol di(meth)acrylate, 2-methyl-1,8-octanediol di(meth)acrylate, 2-ethyl-2-butyl-propanediol di(meth)acrylate, dimerdiol di(meth)acrylate, cyclohexanedimethanol di(meth)acrylate, tricyclodecanedimethanol di(meth)acrylate, hydrogenated bisphenol A di(meth)acrylate, 1,3-butylene glycol di(meth)acrylate, 1,4-butanediol di(meth)acrylate, 1,5-pentanediol di(meth)acrylate, neopentyl glycol di(meth)acrylate, diethylene glycol di(meth)acrylate, triethylene glycol di(meth)acrylate, tetraethylene glycol di(meth)acrylate, polyethylene glycol di(meth)acrylate, dioxane glycol di(meth)acrylate, dipropylene glycol di(meth)acrylate, tripropylene glycol di(meth)acrylate, alkoxylated alkanediol di(meth)acrylate, alkoxylated bisphenol A di(meth)acrylate, hydroxypivalic acid neopentyl glycol di(meth)acrylate, caprolactone-modified hydroxypivalic acid neopentyl glycol di(meth)acrylate, alkoxylated neopentyl glycol di(meth)acrylate, silicone di(meth)acrylate, modified silicone di(meth)acrylate, polycarbonate diol di(meth)acrylate, (hydrogenated) polybutadiene end (meth)acrylate, pentaerythritol tri(meth)acrylate, pentaerythritol tetra(meth)acrylate, dipentaerythritol penta(meth)acrylate, dipentaerythritol (penta)hexa(meth)acrylate, dipentaerythritol hexa(meth)acrylate, trypentaerythritol octa(meth)acrylate, trimethylolpropane tri(meth)acrylate, ditrimethylolpropane tri(meth)acrylate, ditrimethylolpropane tetra(meth)acrylate, (poly)glycerin (poly)acrylate, polypentaerythritol poly(meth)acrylate, isocyanuric acid triacrylate, ethylene oxide-modified (meth)acrylates of these (meth)acrylates, propylene oxide-modified (meth)acrylates of these (meth)acrylates, caprolactone-modified (meth)acrylates of these (meth)acrylates, bifunctional or higher urethane (meth)acrylates, bifunctional or higher epoxy (meth)acrylates, bifunctional or higher polyester (meth)acrylates, fluorine-containing bifunctional or higher (meth)acrylates, and silicone skeleton-containing bifunctional or higher (meth)acrylates.

Of these, from the viewpoint of affinity for epoxy resins, 1,3-butylene glycol di(meth)acrylate, 1,6-hexanediol di(meth)acrylate, 1,7-heptanediol di(meth)acrylate, 1,8-octanediol di(meth)acrylate, 1,9-nonanediol di(meth)acrylate, 1,10-decanediol di(meth)acrylate, 1,12-dodecanediol di(meth)acrylate, 1,16-hexadecanediol di(meth)acrylate, batyl alcohol di(meth)acrylate, 3-methyl 1,5-pentanediol di(meth)acrylate, 2-methyl-1,8-octanediol di(meth)acrylate, 2-ethyl-2-butyl-propanediol di(meth)acrylate, dimerdiol di(meth)acrylate, cyclohexanedimethanol di(meth)acrylate, tricyclodecanedimethanol di(meth)acrylate, hydrogenated bisphenol A di(meth)acrylate, 1,3-butylene glycol di(meth)acrylate, 1,4-butanediol di(meth)acrylate, and 1,5-pentanediol di(meth)acrylate are preferable. 1,3-Butylene glycol di(meth)acrylate, 1,6-hexanediol di(meth)acrylate, 1,7-heptanediol di(meth)acrylate, 1,8-octanediol di(meth)acrylate, 1,9-nonanediol di(meth)acrylate, 1,10-decanediol di(meth)acrylate, cyclohexanedimethanol di(meth)acrylate, tricyclodecanedimethanol di(meth)acrylate, and hydrogenated bisphenol A di(meth)acrylate, are more preferable. 1,3-Butylene glycol di(meth)acrylate and 1,6-hexanediol di(meth)acrylate are still more preferable. 1,3-butylene glycol di(meth)acrylate is particularly preferable.

[Monomer (b)]

The monomer (b) is at least one monomer selected from the group consisting of an epoxy group-containing (meth)acrylate and an aromatic vinyl monomer.

Since the vinyl monomer part contains the unit based on the monomer (b), affinity of the rubber-containing polymer for the epoxy resin is improved, the particles of the rubber-containing polymer are well dispersed in the epoxy resin when blended with the epoxy resin, and thus, the impact resistance is improved.

Examples of the epoxy group-containing (meth)acrylate include glycidyl (meth)acrylate, glycidyl α-ethylacrylate, 3,4-epoxybutyl (meth)acrylate, 1,2-epoxy-4-vinylcyclohexane, and 3,4-epoxycyclohexylmethyl (meth)acrylate. These can be used alone, or two or more thereof can be used in combination. Of these, glycidyl (meth)acrylate is preferable from the viewpoint of dispersibility in the epoxy resin.

Examples of the aromatic vinyl monomer include styrene, α-methylstyrene, p-methylstyrene, p-t-butylstyrene, p-methoxystyrene, o-methoxystyrene, 2,4-dimethylstyrene, chlorostyrene, bromostyrene, vinyltoluene, vinylnaphthalene, and vinylanthracene. These can be used alone, or two or more thereof can be used in combination. Of these, styrene, α-methylstyrene, p-methylstyrene, and p-t-butylstyrene are preferable, and styrene is more preferable, because the polymerization rate can then be easily increased.

The vinyl monomer part may have only a unit based on an epoxy group-containing (meth)acrylate, may have only a unit based on an aromatic vinyl monomer, or may have both a unit based on an epoxy group-containing (meth)acrylate and a unit based on an aromatic vinyl monomer, as a unit based on the monomer (b). From the viewpoint of dispersibility in the epoxy resin, it is preferable to have at least a unit based on an epoxy group-containing (meth)acrylate.

[Monomer (c)]

The monomer (c) is an alkyl (meth)acrylate.

Since the vinyl monomer part has the unit based on the monomer (c), the concentrations of the monomers (a) and (b) in the vinyl monomer part can be suitably adjusted, and the impact resistance-improving effect when the rubber-containing polymer is blended with the epoxy resin is improved.

The alkyl group contained in the alkyl (meth)acrylate may be straight-chained or branched. The number of carbon atoms of the alkyl group is preferably 1 to 6 and more preferably 1 to 3 from the viewpoint of dispersibility in the epoxy resin.

Examples of the alkyl (meth)acrylate include methyl (meth)acrylate, ethyl (meth)acrylate, n-propyl (meth)acrylate, i-propyl (meth)acrylate, n-butyl (meth)acrylate, i-butyl (meth)acrylate, t-butyl (meth)acrylate, and 2-ethylhexyl (meth)acrylate. These can be used alone, or two or more thereof can be used in combination. Of these, from the viewpoint of dispersibility in the epoxy resin, methyl (meth)acrylate, ethyl (meth)acrylate, n-propyl (meth)acrylate, i-propyl (meth)acrylate, n-butyl (meth)acrylate, i-butyl (meth)acrylate, and t-butyl (meth)acrylate are preferable, and methyl (meth)acrylate is more preferable.

### [Other Monomers]

Other monomers are not particularly limited as long as the monomers can be copolymerized with the monomers (a) to (c). Examples of other monomers include a vinyl cyanide monomer such as (meth)acrylonitrile; a vinyl ether monomer such as vinyl methyl ether and vinyl ethyl ether; a vinyl carboxylic acid monomer such as vinyl benzoate, vinyl acetate, and vinyl butyrate; and an olefin monomer such as ethylene, propylene, and butylene. These can be used alone, or two or more thereof can be used

in combination.

[Proportion of Each Unit]

The proportion of the unit based on the monomer (a) to the total mass of the vinyl monomer part is preferably 1% by mass or more and 45% by mass or less, more preferably 5% by mass or more and 40% by mass or less, still more preferably 5% by mass or more and 20% by mass or less, and particularly preferably 5% by mass or more and 10% by mass or less.

The proportion of the unit based on the monomer (b) to the total mass of the vinyl monomer part is preferably 1% by mass or more and 50% by mass or less, more preferably 5% by mass or more and 50% by mass or less, still more preferably 10% by mass or more and 50% by mass or less, and particularly preferably 10% by mass or more and 30% by mass or less.

When the vinyl monomer part has a unit based on an epoxy group-containing (meth)acrylate as a unit based on the monomer (b), the proportion of the unit based on the epoxy group-containing (meth)acrylate to the total mass of the vinyl monomer part is preferably 1% by mass or more and 25% by mass or less, more preferably 5% by mass or more and 25% by mass or less, and still more preferably 5% by mass or more and 12.5% by mass or less.

When the vinyl monomer part has a unit based on an aromatic vinyl monomer as a unit based on the monomer (b), the proportion of the unit based on the aromatic vinyl monomer to the total mass of the vinyl monomer part is preferably 1% by mass or more and 25% by mass or less, more preferably 5% by mass or more and 25% by mass or less, and still more preferably 5% by mass or more and 12.5% by mass or less.

The proportion of the unit (c) to the total mass of the vinyl monomer part is preferably 40% by mass or more and 98% by mass or less, more preferably 50% by mass or more and 90% by mass or less, still more preferably 50% by mass or more and 80% by mass or less, and particularly preferably 55% by mass or more and 70% by mass or less.

The total proportion of the unit (a), the unit (b), and the unit (c) to the total mass of the vinyl monomer part is preferably 80% by mass or more, more preferably 90% by mass or more, and still more preferably 95% by mass or more. The upper limit is not particularly limited and may be 100% by mass.

### [Method for Producing Rubber-Containing Polymer]

The rubber-containing polymer can be produced by polymerizing a monomer mixture containing the monomer (a), the monomer (b), and the monomer (c), for example, in the presence of a latex (rubber latex) of a rubbery polymer.

The proportion (% by mass) of each of the monomer (a), the monomer (b), and the monomer (c) to the total mass of the monomer mixture is the same as the proportion of each of the unit based on the monomer (a), the unit based on the monomer (b), and the unit based on the monomer (c) to the total mass of the vinyl monomer part.

Examples of the polymerization conditions for polymerizing the monomer mixture to form a vinyl monomer part include conditions of 55° C. or higher and 90° C. or lower for 1 hour or longer and 4 hours or shorter.

After polymerizing the monomer mixture to form a vinyl monomer part, the rubber-containing polymer may be recovered as a powder from the obtained latex of the rubber-containing polymer.

A known method may be used as a method for recovering the rubber-containing polymer as a powder. For example, a direct drying method such as a spray drying method or a coagulation method can be used.

### ((Meth)Acrylic Copolymer)

The (meth)acrylic copolymer (hereinafter, also referred to as “copolymer”) has a constituting unit derived from the macromonomer (d) and a constituting unit derived from the vinyl monomer (e).

In the present embodiment, since the copolymer has a constituting unit derived from the macromonomer (d), the epoxy resin composition containing the copolymer has a low viscosity, and has excellent process suitability and degree of freedom in blending.

The copolymer has a structure of a graft copolymer or a block copolymer in which a polymer chain derived from the macromonomer (d) and a polymer chain consisting of a constituting unit derived from the vinyl monomer (e) are bonded.

The macromonomer (d) has a function of improving the compatibility with the epoxy resin in the epoxy resin composition and/or the cured product thereof when the (meth)acrylic copolymer is blended with the epoxy resin, forming a microphase-separated structure, and increasing the interfacial strength between the rubber part and the epoxy resin.

In the copolymer, the composition of the monomer that constitutes the macromonomer (d) is usually different from the composition of the vinyl monomer (e). The composition indicates the type and content proportion of the monomer.

The vinyl monomer (e) has a function of being phase-separated from the epoxy resin in the epoxy resin composition and/or the cured product thereof when the (meth)acrylic copolymer is blended with the epoxy resin, dispersing by forming a microphase-separated structure while becoming rubbery, and improving the toughness and impact resistance of the cured product.

It is preferable that the polymer chain derived from the macromonomer (d) and the polymer chain consisting of the constituting unit derived from the vinyl monomer (e) can be phase-separated (micro-phase separation).

The composition of the monomer that constitutes the macromonomer (d) is usually different from the composition of the vinyl monomer (e). Here, the composition indicates the type and content proportion of the monomer.

The constituting unit of the macromonomer (d) and the constituting unit derived from the vinyl monomer (e) are preferably the constituting units derived from the (meth)acrylic monomer.

The content of the constituting units derived from the (meth)acrylic monomer in the copolymer is preferably 20% by mass or more and 100% by mass or less with respect to the total mass (100% by mass) of all the constituting units that constitute the copolymer, and is more preferably 40% by mass or more and 100% by mass or less.

[Macromonomer (d)]

The macromonomer (d) has a radically polymerizable group or an addition-reactive functional group.

When the macromonomer (d) has a radically polymerizable group, a copolymer can be obtained by copolymerizing the macromonomer (d) and the vinyl monomer (e) by radical polymerization.

When the macromonomer (d) has an addition-reactive functional group, a copolymer can be obtained by causing a functional group of a polymer consisting of a constituting unit derived from the vinyl monomer (e) to react with a macromonomer having an addition-reactive functional group.

Examples of the addition-reactive functional group include a hydroxyl group, an isocyanate group, an epoxy group, a carboxyl group, an acid anhydride group, an amino group, an amide group, a thiol group, and a carbodiimide group.

Examples of the combination of the addition-reactive functional group and the functional group capable of reacting with the functional group include the following combinations.

A combination of a hydroxyl group and a carboxyl group or an acid anhydride group.

A combination of an isocyanate group and a hydroxyl group, a thiol group, or a carboxyl group.

A combination of an epoxy group and an amino group.

A combination of a carboxyl group and an epoxy group or a carbodiimide group.

A combination of an amino group and a carboxyl group.

A combination of an amide group and a carboxyl group.

A combination of a thiol group and an epoxy group.

The macromonomer (d) may have either a radically polymerizable group or an addition-reactive functional group, or may have both.

When the macromonomer (d) has a radically polymerizable group, the number of radically polymerizable groups in the macromonomer (d) may be one or more, but one is preferable. When the macromonomer (d) has an addition-reactive functional group, the number of addition-reactive functional groups in the macromonomer (d) may be one or more, but one is preferable. When the macromonomer (d) has both a radically polymerizable group and an addition-reactive functional group, it is preferable that the macromonomer (d) have one radically polymerizable group and one addition-reactive functional group, but it may also have two or more radically polymerizable groups and addition-reactive functional groups.

The macromonomer (d) preferably has a radically polymerizable group from the viewpoint that copolymerization with the vinyl monomer (e) is possible. When the copolymer is a copolymer of the macromonomer (d) and the vinyl monomer (e), the viscosity of the epoxy resin composition tends to be low when blended with the epoxy resin composition, compared to a case wherein the copolymer is a reaction product of a functional group of a polymer consisting of a constituting unit derived from the vinyl monomer (e) and a macromonomer having the addition-reactive functional group. The copolymer is also excellent in that it is easy to control the amount of the macromonomer (d) introduced.

As the radically polymerizable group of the macromonomer (d), a group having an ethylenically unsaturated bond is preferable. Examples of the group having an ethylenically unsaturated bond include CH₂═C(COOR⁰)—CH₂—, a (meth)acryloyl group, a 2-(hydroxymethyl)acryloyl group, and a vinyl group. Here, R⁰ represents a hydrogen atom, a substituted or unsubstituted alkyl group, a substituted or unsubstituted alicyclic group, a substituted or unsubstituted aryl group, a substituted or unsubstituted heteroaryl group, a substituted or unsubstituted non-aromatic heterocyclic group, a substituted or unsubstituted aralkyl group, a substituted or unsubstituted alkaryl group, a substituted or unsubstituted organosilyl group, or a substituted or unsubstituted (poly)organosiloxane group.

The substituted alkyl group indicates an alkyl group having a substituent. The same applies to other groups.

Examples of the unsubstituted alkyl group include a branched or straight-chain alkyl group having 1 to 22 carbon atoms. Specific examples of branched or straight-chain alkyl groups having 1 to 22 carbon atoms include a methyl group, an ethyl group, an n-propyl group, an i-propyl group, an n-butyl group, a t-butyl group, an i-butyl group, a pentyl group (amyl group), an i-pentyl group, a hexyl group, a heptyl group, a 2-ethylhexyl group, an octyl group, an i-octyl group, a nonyl group, an i-nonyl group, a decyl group, an i-decyl group, an undecyl group, a dodecyl (lauryl group), a tridecyl group, a tetradecyl group, a pentadecyl group, a hexadecyl group, a heptadecyl group, an octadecyl group (stearyl group), an i-octadecyl group, a nonadecyl group, an icosyl group, and a docosyl group.

The unsubstituted alicyclic group may be a monocyclic group or a polycyclic group, and examples thereof include an alicyclic group having 3 to 20 carbon atoms. The alicyclic group is preferably a saturated alicyclic group, and specific examples thereof include a cyclopropyl group, a cyclobutyl group, a cyclopentyl group, a cyclohexyl group, a cycloheptyl group, a bicyclo[2.2.1]heptyl group, a cyclooctyl group, an isobornyl group, and an adamantyl group.

Examples of the unsubstituted aryl group include an aryl group having 6 to 18 carbon atoms. Specific examples of the aryl group having 6 to 18 carbon atoms include a phenyl group and a naphthyl group.

Examples of the unsubstituted heteroaryl group include a pyridyl group and a carbazolyl group.

Examples of the unsubstituted non-aromatic heterocyclic group include a pyrrolidinyl group, a pyrrolidone group, and a lactam group.

Examples of the unsubstituted aralkyl group include a benzyl group and a phenylethyl group.

Examples of the substituted or unsubstituted organosilyl group include —SiR¹⁷R¹⁸R¹⁹ (wherein R¹⁷, R¹⁸ and R¹⁹ can be any of a substituted or unsubstituted alkyl group, a substituted or unsubstituted alicyclic group, or a substituted or unsubstituted aryl group).

The substituted or unsubstituted alkyl group in R¹⁷ to R¹⁹ is the same as the substituted or unsubstituted alkyl group in R⁰, and examples thereof include a methyl group, an ethyl group, an n-propyl group, an n-butyl group, an n-amyl group, an n-hexyl group, an n-octyl group, an n-dodecyl group, a stearyl group, a lauryl group, an isopropyl group, an isobutyl group, an s-butyl group, a 2-methylisopropyl group, and a benzyl group. The substituted or unsubstituted alicyclic group is the same as the substituted or unsubstituted alicyclic group in R⁰, and examples thereof include a cyclohexyl group. The substituted or unsubstituted aryl group is the same as the substituted or unsubstituted aryl group in R⁰, and examples thereof include a phenyl group and a p-methylphenyl. R¹⁷ to R¹⁹ may be the same or different from each other.

Examples of the substituted or unsubstituted (poly)organosiloxane group include —SiR³⁰R³¹—OR³², —(SiR³³R³⁴—O-)m-R³⁵ (wherein R³⁰ to R³⁵ independently represent a substituted or unsubstituted alkyl group, a substituted or unsubstituted alicyclic group, or a substituted or unsubstituted aryl group, and m represents an integer from 1 to 100). The alkyl group, the alicyclic group, and the aryl group in R³⁰ to R³⁵ are the same as those in R¹⁷ to R¹⁹.

Examples of substituents (substituents such as a substituted alkyl group, a substituted alicyclic group, a substituted aryl group, a substituted heteroaryl group, a substituted non-aromatic heterocyclic group, a substituted aralkyl group, a substituted alkaryl group, a substituted organosilyl group, or a substituted (poly)organosiloxane group) in R⁰ include at least one selected from a group consisting of an alkyl group (excluding a case wherein R⁰ is a substituted alkyl group), an aryl group, —COOR¹¹, a cyano group, —OR¹², —R¹³R¹⁴, —CONR¹⁵R¹⁶, a halogen atom, an allyl group, an epoxy group, a siloxy group, and a group exhibiting hydrophilicity or ionicity. Here, R¹¹ to R¹⁶ independently represent a hydrogen atom, a substituted or unsubstituted alkyl group, a substituted or unsubstituted alicyclic group, or a substituted or unsubstituted aryl group.

The alkyl group, the alicyclic group, and the aryl group in R¹¹ to R¹⁶ are the same as those described in R¹⁷ to R¹⁹.

Examples of the alkyl group and the aryl group in the above-described substituent include those similar to the above-described unsubstituted alkyl group and unsubstituted aryl group.

As R¹¹ of —COOR¹¹, a hydrogen atom or an unsubstituted alkyl group is preferable. In other words, —COOR¹¹ is preferably a carboxy group or an alkoxycarbonyl group. Examples of the alkoxycarbonyl group include a methoxycarbonyl group.

As R¹² of —OR¹², a hydrogen atom or an unsubstituted alkyl group is preferable. In other words, —OR¹² is preferably a hydroxy group or an alkoxy group. Examples of the alkoxy group include an alkoxy group having 1 to 12 carbon atoms, and specific examples thereof include a methoxy group.

Examples of —NR¹³R¹⁴ include an amino group, a monomethylamino group, and a dimethylamino group.

Examples of —CONR¹⁵R¹⁶ include a carbamoyl group (—CONH₂), an N-methylcarbamoyl group (—CONHCH₃), and an N,N-dimethylcarbamoyl group (dimethylamide group: —CON(CH₃)₂).

Examples of the halogen atom include a fluorine atom, a chlorine atom, a bromine atom, and an iodine atom.

Examples of the group exhibiting hydrophilicity or ionicity include a cationic substituent such as an alkali salt of a carboxy group, an alkali salt of a sulfoxy group, a poly(alkylene oxide) group (polyethylene oxide group, polypropylene oxide group, and the like), and a quaternary ammonium base.

The macromonomer (d) has two or more constituting units derived from a monomer (hereinafter, also referred to as “monomer (d1)”) having a radically polymerizable group. The two or more constituting units of the macromonomer (d) may be the same or different.

As the radically polymerizable group contained in the monomer (d1), a group having an ethylenically unsaturated bond is preferable similar to the radical polymerizable group preferably possessed by the macromonomer (d). In other words, the monomer (d1) is preferably a vinyl monomer.

Examples of the monomer (d1) include the following:

hydrocarbon group-containing (meth)acrylate esters such as methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, isoamyl (meth)acrylate, hexyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, lauryl (meth)acrylate, hexadecyl (meth)acrylate, stearyl (meth)acrylate, isostaryl (meth)acrylate, phenyl (meth)acrylate, benzyl (meth)acrylate, cyclohexyl (meth)acrylate, tetrahydrofurfuryl (meth)acrylate, isobornyl (meth)acrylate, 3,5,5-trimethylcyclohexyl (meth)acrylate, dicyclopentanyl (meth)acrylate, dicyclopentenyl (meth)acrylate, dicyclopentenyloxyethyl (meth)acrylate, terpene acrylate and derivatives thereof, hydrogenated rosin acrylates and derivatives thereof, and docosyl (meth)acrylate;

hydroxyl group-containing (meth)acrylate esters such as 2-hydroxyethyl (meth)acrylate, 2-hydroxypropyl (meth)acrylate, 2-hydroxybutyl (meth)acrylate, 3-hydroxybutyl (meth)acrylate, 4-hydroxybutyl (meth)acrylate, and glycerol (meth)acrylate;

carboxyl group-containing vinyl monomers such as (meth)acrylic acid, 2-(meth)acryloyloxyethyl hexahydrophthalic acid, 2-(meth)acryloyloxypropyl hexahydrophthalic acid, 2-(meth)acryloyloxyethyl phthalic acid, 2-(meth)acryloyloxy propylphthalic acid, 2-(meth)acryloyloxyethyl maleic acid, 2-(meth)acryloyloxypropyl maleic acid, 2-(meth)acryloyloxyethyl succinic acid, 2-(meth)acryloyloxypropyl succinic acid, crotonic acid, phthalic acid, maleic acid, itaconic acid, citraconic acid, monomethyl maleate, monoethyl maleate, monooctyl maleate, monomethyl itaconic acid, monoethyl itaconic acid, monobutyl itaconic acid, monooctyl itaconic acid, monomethyl fumarate, monoethyl fumarate, monobutyl fumarate, monooctyl fumarate, and monoethyl citraconic acid;

acid anhydride group-containing vinyl monomers such as maleic anhydride and itaconic anhydride;

amide bond-containing vinyl monomers such as amide bond-containing chain vinyl monomers (for example, (meth)acrylamide, N,N-dimethyl(meth)acrylamide, N,N-diethyl (meth)acrylamide, N-isopropyl (meth)acrylamide, N-t-butyl (meth)acrylamide, N-t-octyl (meth)acrylamide, N-methylol (meth)acrylamide, hydroxyethyl (meth)acrylamide, N-methoxymethyl (meth)acrylamide, N-butoxymethyl (meth)acrylamide, diacetone (meth)acrylamide, N,N-dimethylaminoethyl (meth)acrylamide, N,N-dimethylaminopropyl (meth)acrylamide, N-vinylacetamide, maleic acid amide, N,N′-methylenebis(meth)acrylamide, and amide bond-containing cyclic vinyl monomers (for example, (meth)acryloylmorpholine, N-vinylpyrrolidone, N-vinyl-ε-caprolactam, and maleimide);

unsaturated dicarboxylic acid diester monomers such as dimethyl malate, dibutyl malate, dimethyl fumarate, dibutyl fumarate, dibutyl itaconate, and diperfluorocyclohexyl fumarate;

cyclic ether group-containing vinyl monomers such as glycidyl (meth)acrylate, glycidyl α-ethylacrylate, 3,4-epoxybutyl(meth)acrylate, 1,2-epoxy-4-vinylcyclohexane, 3,4-epoxycyclohexylmethyl (meth)acrylate, β-methylglycidyl (meth)acrylate, (3-ethyloxetan-3-yl)methyl (meth)acrylate, tetrahydrofurfuryl (meth)acrylate, (2-methyl-2-ethyl-1,3-dioxolane-4-yl) (meth)acrylate, and (5-ethyl-1,3-dioxane-5-yl)methyl (meth)acrylate;

amino group-containing (meth)acrylate ester-based vinyl monomers such as dimethylaminoethyl (meth)acrylate and diethylaminoethyl (meth)acrylate;

polyfunctional vinyl monomers such as divinylbenzene, ethylene glycol di(meth) acrylate, 1,3-butylene glycol di(meth) acrylate, 1,4-butanediol di(meth)acrylate, 1,6-hexanediol di(meth)acrylate, di-ethylene glycol di(meth)acrylate, triethylene glycol di(meth)acrylate, tetraethylene glycol di(meth)acrylate, polyethylene glycol di(meth)acrylate, tripropylene glycol di(meth)acrylate, neopentyl glycol di(meth)acrylate, 1,9-nonanediol di(meth)acrylate, 1,10-decanediol di(meth)acrylate, trimethylpropane tri(meth)acrylate, pentaerythritol tetra(meth)acrylate, dipentaerythritol hexa(meth)acrylate, allyl (meth)acrylate, triallyl cyanurate, diallyl maleate, and polypropylene glycol diallyl ether;

heterocyclic monomers such as vinylpyridine, vinylcarbazole, (3-ethyloxetan-3-yl) methyl acrylate, 2-methyl-2-ethyl-1,3-dioxolan-4-yl)methyl acrylate, and cyclic trimethylolpropane formal acrylate;

glycol ester monomers such as polyethylene glycol (meth)acrylate, polypropylene glycol (meth)acrylate, methoxyethyl (meth)acrylate, ethoxyethyl (meth)acrylate, n-butoxyethyl (meth)acrylate, isobutoxyethyl (meth)acrylate, t-butoxyethyl (meth)acrylate, ethoxyethoxyethyl (meth)acrylate, phenoxyethyl (meth)acrylate, nonylphenoxyethyl (meth)acrylate, 3-methoxybutyl (meth)acrylate, acetoxyethyl (meth)acrylate, “Placcel FM” (caprolactone-added monomer manufactured by Daicel Corporation, product name), “Blemmer PME-100” (methoxypolyethylene glycol methacrylate (in which the number of ethylene glycol chains is 2) manufactured by NOF Corporation, product name), “Blemmer PME-200” (methoxypolyethylene glycol methacrylate (in which the number of ethylene glycol chains is 4) manufactured by NOF Corporation, product name), “Blemmer PME-400” (methoxypolyethylene glycol methacrylate (in which the number of ethylene glycol chains is 9) manufactured by NOF Corporation, product name), “Blemmer 50POEP-800B” (octoxy polyethylene glycol-polypropylene glycol-methacrylate (in which the number of ethylene glycol chains is 8 and propylene glycol chain is 6) manufactured by NOF Corporation, product name), “Blemmer 20 ANEP-600” (nonylphenoxy(ethylene glycol-polypropylene glycol)) manufactured by NOF Corporation, trademark), “Blemmer AME-100 (manufactured by NOF Corporation, product name), “Blemmer AME-200” (manufactured by NOF Corporation, product name), and “Blemmer 50AOEP-800B” (manufactured by NOF Corporation, product name);

silane coupling agent-containing monomers such as 3-(meth)acryloxypropyltrimethoxysilane, 3-(meth)acryloxypropylmethyldiethoxysilane, 3-(meth)acryloxypropyltriethoxysilane, 3-acryloxypropyltrimethoxysilane, vinyltrimethoxysilane, and vinyltriethoxysilane;

organosilyl group-containing monomers other than silane coupling agent-containing monomers, such as trimethylsilyl (meth)acrylate, triethylsilyl (meth)acrylate, tri-n-propylsilyl (meth)acrylate, tri-n-butylsilyl (meth)acrylate, tri-n-amylsilyl (meth)acrylate, tri-n-hexylsilyl (meth)acrylate, tri-n-octylsilyl (meth)acrylate, tri-n-dodecylsilyl (meth)acrylate, triphenylsilyl (meth)acrylate, tri-p-methylphenylsilyl (meth)acrylate, tribenzylsilyl (meth)acrylate, triisopropylsilyl (meth)acrylate, triisobutylsilyl (meth)acrylate, tri-s-butylsilyl (meth)acrylate, tri-2-methylisopropylsilyl (meth)acrylate, tri-t-butylsilyl (meth)acrylate, ethyldimethylsilyl (meth)acrylate, n-butyldimethylsilyl (meth)acrylate, diisopropyl-n-butylsilyl (meth)acrylate, n-octyldi-n-butylsilyl (meth)acrylate, diisopropylstearylsilyl (meth)acrylate, dicyclohexylphenylsilyl (meth)acrylate, t-butyldiphenylsilyl (meth)acrylate, lauryldiphenylsilyl (meth)acrylate, triisopropylsilyl methyl malate, triisopropylsilyl amyl malate, tri-n-butylsilyl-n-butyl malate, t-butyldiphenylsilyl methyl malate, t-butyldiphenylsilyl-n-butyl malate, triisopropylsilyl methyl fumarate, triisopropylsilylamyl fumarate, tri-n-butylsilyl-n-butyl fumarate, t-butyldiphenylsilyl methyl fumarate, t-butyldiphenylsilyl-n-butyl fumarate, Silaplane FM-0711 (manufactured by JNC Corporation, product name), Silaplane FM-0721 (manufactured by JNC Corporation, product name), Silaplane FM-0725 (manufactured by JNC Corporation, product name), Silaplane TM-0701 (manufactured by JNC Corporation, product name), Silaplane TM-0701T (manufactured by Corporation, product name), X-22-174ASX (manufactured by Shin-Etsu Chemical Co., Ltd., product name), X-22-174BX (manufactured by Shin-Etsu Chemical Co., Ltd., product name), KF-2012 (manufactured by Shin-Etsu Chemical Co., Ltd., product name), X-22-2426 (manufactured by Shin-Etsu Chemical Co., Ltd., product name), and X-22-2404 (manufactured by Shin-Etsu Chemical Co., Ltd., product name);

halogenated olefins such as vinyl chloride, vinylidene chloride, vinyl fluoride, vinylidene fluoride, and chlorotrifluoroethylene;

isocyanato group-containing monomers such as 2-isocyanatoethyl (meth)acrylate;

fluorine-containing monomers (excluding halogenated olefins) such as 2,2,2-trifluoroethyl (meth)acrylate, 2,2,3,3,3-pentafluorophenyl (meth)acrylate, 2-(perfluorobutyl)ethyl (meth)acrylate, 3-(perfluorobutyl)-2-hydroxypropyl (meth)acrylate, 2-(perfluorohexyl)ethyl (meth)acrylate, 3-perfluorohexyl-2-hydroxypropyl (meth)acrylate, 3-(perfluoro-3-methylbutyl)-2-hydroxypropyl (meth)acrylate, 2,2,3,3-tetrafluoropropyl (meth)acrylate, 1H,1H,5H-octafluoropentyl (meth)acrylate, 1H,1H,5H-octafluoropentyl (meth)acrylate, 1H,1H,2H,2H-tridecafluorooctyl (meth)acrylate, 1H-1-(trifluoromethyl)trifluoroethyl (meth)acrylate, 1H,1H,3H-hexafluorobutyl (meth)acrylate, and 1,2,2,2-tetrafluoro-1-(trifluoromethyl)ethyl (meth)acrylate;

monomers with an acetal structure such as 1-butoxyethyl (meth)acrylate, 1-(2-ethylhexyloxy)ethyl (meth)acrylate, 1-(cyclohexyloxy)ethyl methacrylate, and 2-tetrahydropyranyl (meth)acrylate; and

other vinyl monomers such as 4-methacryloyloxybenzophenone, styrene, α-methylstyrene, vinyltoluene, (meth)acrylonitrile, vinyl chloride, vinyl acetate, and vinyl propionate.

The monomer (d1) may be used alone, or two or more thereof may be used in combination.

From the viewpoints of compatibility with the epoxy resin, the glass transition temperature of the macromonomer (d) being in a suitable range, and availability, at least some of the monomers (d1) are preferably a (meth)acrylic monomer, more preferably a methacrylic monomer, and particularly preferably a methacrylate (methacrylate ester) which may have a substituent.

Specifically, methyl methacrylate, n-butyl methacrylate, lauryl methacrylate, dodecyl methacrylate, stearyl methacrylate, 2-ethylhexyl methacrylate, 2-hydroxyethyl methacrylate, and 4-hydroxybutyl methacrylate are preferable, and methyl methacrylate, n-butyl methacrylate, 2-ethylhexyl methacrylate are more preferable.

The content of methacrylate (methacrylate which may have a substituent) in the total amount of raw material monomers for obtaining the macromonomer (d) is not particularly limited. From the viewpoint of compatibility with the epoxy resin, the glass transition temperature of the macromonomer (d), and the ease of the polymerization reaction for obtaining the macromonomer (d), the content of methacrylate is preferably 50% by mass or more, preferably 60% by mass or more, and further preferably 80% by mass or more. The content of methacrylate may be 100% by mass.

The same applies to the amount of methacrylate units among all the units of the macromonomer (d).

As the constituting unit derived from the monomer (d1), a constituting unit (hereinafter, also referred to as “constituting unit (da)”) represented by the following Formula (da) is preferable. In other words, the macromonomer (d) preferably has a radically polymerizable group and has two or more constituting units (da).

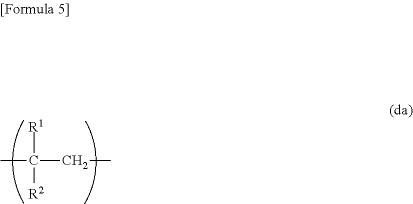

In the formula, R¹ represents a hydrogen atom, a methyl group, or CH₂OH, and R² represents OR³, a halogen atom, COR⁴, COOR⁵, CN, CONR⁶R⁷, NHCOR⁸, or R⁹.

R³ to R⁸ are independently represent a hydrogen atom, a substituted or unsubstituted alkyl group, a substituted or unsubstituted alicyclic group, a substituted or unsubstituted aryl group, a substituted or unsubstituted heteroaryl group, a substituted or unsubstituted non-aromatic heterocyclic group, a substituted or unsubstituted aralkyl group, a substituted or unsubstituted alkaryl group, a substituted or unsubstituted organosilyl group, or a substituted or unsubstituted (poly)organosiloxane group. The substituents that substitute these groups are at least one selected from a group consisting of an alkyl group, an aryl group, a heteroaryl group, a non-aromatic heterocyclic group, an aralkyl group, an alkaryl group, a carboxylic acid group, a carboxylic acid ester group, an epoxy group, a hydroxy group, an alkoxy group, a primary amino group, a secondary amino group, a tertiary amino group, an isocyanato group, a sulfonic acid group, and a halogen atom.

R⁹ represents a substituted or unsubstituted aryl group, a substituted or unsubstituted heteroaryl group, or a substituted or unsubstituted non-aromatic heterocyclic group, and the substituents that substitute these groups are at least one selected from a group consisting of an alkyl group, an aryl group, a heteroaryl group, a non-aromatic heterocyclic group, an aralkyl group, an alkaryl group, a carboxylic acid group, a carboxylic acid ester group, an epoxy group, a hydroxy group, an alkoxy group, a primary amino group, a secondary amino group, a tertiary amino group, an isocyanato group, a sulfonic acid group, a substituted or unsubstituted olefin group, and a halogen atom.

The unsubstituted alkyl group, the unsubstituted alicyclic group, the unsubstituted aryl group, the unsubstituted heteroaryl group, the unsubstituted non-aromatic heterocyclic group, the unsubstituted aralkyl group, the unsubstituted alkaryl group, the unsubstituted organosilyl group, and the unsubstituted (poly)organosiloxane group in R³ to R⁸ are the same as those described in R⁰ described above.

Among the substituents (substituents in a substituted alkyl group, a substituted alicyclic group, a substituted aryl group, a substituted heteroaryl group, a substituted non-aromatic heterocyclic group, a substituted aralkyl groups, a substituted alkaryl group, a substituted organosilyl group, a substituted (poly)organosiloxane group or the like) in R³ to R⁸, the alkyl group, the aryl group, the heteroaryl group, the non-aromatic heterocyclic group, the aralkyl group, the alkaryl group, and the halogen atom are the same as those in R⁰ described above.

Examples of the carboxylic acid ester group include a group in which R¹¹ of the —COOR¹ is a substituted or unsubstituted alkyl group, a substituted or unsubstituted alicyclic group, or a substituted or unsubstituted aryl group.

Examples of the alkoxy group include a group in which R¹² of —OR¹² is an unsubstituted alkyl group.

Examples of the secondary amino group include a group in which R¹³ of —NR¹³R¹⁴ is a hydrogen atom, and R¹⁴ is a substituted or unsubstituted alkyl group, a substituted or unsubstituted alicyclic group, or a substituted or unsubstituted aryl group.

Examples of the tertiary amino group include a group in which R¹³ and R¹⁴ of —NR¹³R¹⁴ are substituted or unsubstituted alkyl groups, substituted or unsubstituted alicyclic groups, or substituted or unsubstituted aryl groups.

The unsubstituted aryl group, the unsubstituted heteroaryl group, and the unsubstituted non-aromatic heterocyclic group in R⁹ are the same as those in R⁰ described above.

Among the substituents (substituents such as a substituted aryl group, a substituted heteroaryl group, or a substituted non-aromatic heterocyclic groups) in R⁹, the alkyl group, the aryl group, the heteroaryl group, the non-aromatic heterocyclic group, the aralkyl group, the alkaryl group, the carboxylic acid group, the carboxylic acid ester group, the alkoxy group, the primary amino group, the secondary amino group, the tertiary amino group and halogen atom are the same as those in R³ to R⁸ described above.

Examples of the unsubstituted olefin group include an allyl group and the like.

Examples of the substituent in the olefin group having a substituent include the same as the substituents in R⁹.

The constituting unit (da) is a constituting unit derived from CH₂═CR¹R²

Specific examples of CH₂═CR¹R² include the following:

hydrophobic group-containing (meth)acrylate ester monomers such as substituted or unsubstituted alkyl (meth)acrylates (for example, methyl (meth)acrylate, ethyl (meth)acrylate, n-propyl (meth)acrylate, i-propyl (meth)acrylate, n-butyl (meth)acrylate, i-butyl (meth)acrylate, t-butyl (meth)acrylate, 2-ethylhexyl (meth)acrylate, lauryl (meth)acrylate, stearyl (meth)acrylate, i-stearyl (meth)acrylate, i-decyl (meth)acrylate, n-decyl (meth)acrylate, behenyl (meth)acrylate, 1-methyl-2-methoxyethyl (meth)acrylate, 3-methoxybutyl (meth)acrylate, and 3-methyl-3-methoxybutyl (meth)acrylate), substituted or unsubstituted aralkyl (meth)acrylates (for example, benzyl (meth)acrylate, m-methoxyphenyl ethyl (meth)acrylate, and p-methoxyphenyl ethyl (meth)acrylate), substituted or unsubstituted aryl (meth)acrylates (for example, phenyl (meth)acrylate, m-methoxyphenyl (meth)acrylate, p-methoxyphenyl (meth)acrylate, and o-methoxyphenyl ethyl (meth)acrylate), alicyclic (meth)acrylates (for example, isobornyl (meth)acrylate and cyclohexyl (meth)acrylate), and halogen atom-containing (meth)acrylates (for example, trifluoroethyl (meth)acrylate, perfluorooctyl (meth)acrylate, and perfluorocyclohexyl (meth)acrylate);

oxyethylene group-containing (meth)acrylate ester monomers such as 2-methoxyethyl (meth)acrylate, 2-ethoxyethyl (meth)acrylate, 2-butoxyethyl (meth)acrylate, butoxydiethylene glycol (meth)acrylate, methoxytriethylene glycol (meth)acrylate, methoxypolyethylene glycol (meth)acrylate, phenoxyethyl (meth)acrylate, and 2-(2-ethylhexaoxy) ethyl (meth)acrylate;

hydroxy group-containing (meth)acrylate ester monomers such as 2-hydroxyethyl (meth)acrylate, 2-hydroxypropyl (meth)acrylate, 4-hydroxybutyl (meth)acrylate, and glycerol (meth)acrylate;

end alkoxy-allylated polyether monomers such as methoxypolyethylene glycol allyl ether, methoxypolypropylene glycol allyl ether, butoxypolyethylene glycol allyl ether, butoxypolypropylene glycol allyl ether, methoxypolyethylene glycol-polypropylene glycol allyl ether, and butoxypolyethylene glycol-polypropylene glycol allyl ether;

epoxy group-containing vinyl monomers such as glycidyl (meth)acrylate, glycidyl α-ethyl acrylate, and 3,4-epoxybutyl (meth)acrylate;

amide bond-containing vinyl monomers such as (meth)acrylamide, N,N-dimethyl(meth)acrylamide, N,N-diethyl(meth)acrylamide, N-isopropyl(meth)acrylamide, N-t-butyl(meth)acrylamide, N-t-octyl(meth)acrylamide, N-methylol(meth)acrylamide, hydroxyethyl(meth)acrylamide, N-methoxymethyl(meth)acrylamide, N-butoxymethyl(meth)acrylamide, diacetone (meth)acrylamide, N,N-dimethylaminoethyl(meth)acrylamide, N,N-dimethylaminopropyl(meth)acrylamide, N-vinylacetamide, N,N′-methylenebis(meth)acrylamide, (meth)acryloylmorpholine, N-vinylpyrrolidone, and N-vinyl-ε-caprolactam;

primary or secondary amino group-containing vinyl monomers such as butylaminoethyl (meth)acrylate;

tertiary amino group-containing vinyl monomers such as dimethylaminoethyl (meth)acrylate, diethylaminoethyl (meth)acrylate, dimethylaminopropyl (meth)acrylate, dimethylaminobutyl (meth)acrylate, and dibutylaminoethyl (meth)acrylate;

heterocyclic basic monomers such as vinylpyridine, vinylcarbazole, (3-ethyloxetan-3-yl) methyl acrylate, 2-methyl-2-ethyl-1,3-dioxolan-4-yl) methyl acrylate, and cyclic trimethylolpropane formal acrylate;

organosilyl group-containing vinyl monomers such as trimethylsilyl (meth)acrylate, triethylsilyl (meth)acrylate, tri-n-propylsilyl (meth)acrylate, tri-n-butylsilyl (meth)acrylate, tri-n-amylsilyl (meth)acrylate, tri-n-hexylsilyl (meth)acrylate, tri-n-octylsilyl (meth)acrylate, tri-n-dodecylsilyl (meth)acrylate, triphenylsilyl (meth)acrylate, tri-p-methylphenylsilyl (meth)acrylate, tribenzylsilyl (meth)acrylate, triisopropylsilyl (meth)acrylate, triisobutylsilyl (meth)acrylate, tri-s-butylsilyl (meth)acrylate, tri-2-methylisopropylsilyl (meth)acrylate, tri-t-butylsilyl (meth)acrylate, ethyldimethylsilyl (meth)acrylate, n-butyldimethylsilyl (meth)acrylate, diisopropyl-n-butylsilyl (meth)acrylate, n-octyldi-n-butylsilyl (meth)acrylate, diisopropylstearylsilyl (meth)acrylate, dicyclohexylphenylsilyl (meth)acrylate, t-butyldiphenylsilyl (meth)acrylate, and lauryldiphenylsilyl (meth)acrylate;

carboxy group-containing ethylenically unsaturated monomers such as methacrylate, acrylic acid, vinyl benzoate, monohydroxyethyl tetrahydrophthalate (meth)acrylate, monohydroxypropyl tetrahydrophthalate (meth)acrylate, monohydroxybutyl tetrahydrophthalate (meth)acrylate, monohydroxyethyl phthalate (meth)acrylate, monohydroxypropyl phthalate (meth)acrylate, monohydroxyethyl succinate (meth)acrylate, monohydroxypropyl succinate (meth)acrylate, monohydroxyethyl maleate (meth)acrylate, and monohydroxypropyl maleate (meth)acrylate;

cyano group-containing vinyl monomers such as acrylonitrile and methacrylonitrile;

vinyl ether monomers such as alkyl vinyl ethers (for example, ethyl vinyl ether, propyl vinyl ether, butyl vinyl ether, hexyl vinyl ether, and 2-ethylhexyl vinyl ethers), and cycloalkyl vinyl ethers (for example, cyclohexyl vinyl ether);

vinyl ester monomers such as vinyl acetate, vinyl propionate, vinyl butyrate, and vinyl benzoate;

aromatic vinyl monomers such as styrene, vinyltoluene, and α-methylstyrene; and halogenated olefins such as vinyl chloride and vinyl fluoride.

The macromonomer (d) may further have a constituting unit other than the constituting unit (da). Examples of other constituting units include a constituting unit derived from a monomer that does not correspond to CH₂═CR¹R² among the monomers listed as examples of the above-described monomer (d1).

Preferred specific examples of other constituting units include the following constituting units derived from monomers:

organosilyl group-containing vinyl monomers such as triisopropylsilylmethyl malate, triisopropylsilylamyl malate, tri-n-butylsilyl-n-butyl malate, t-butyldiphenylsilylmethyl malate, t-butyldiphenylsilyl-n-butyl malate, triisopropylsilylmethyl fumarate, triisopropylsilylamyl fumarate, tri-n-butylsilyl-n-butyl fumarate, t-butyldiphenylsilylmethyl fumarate, and t-butyldiphenylsilyl-n-butyl fumarate;

acid anhydride group-containing vinyl monomers such as maleic anhydride and itaconic anhydride;

carboxy group-containing ethylenically unsaturated monomers such as crotonic acid, fumaric acid, itaconic acid, maleic acid, citraconic acid, monomethyl maleate, monoethyl maleate, monobutyl maleate, monooctyl maleate, monomethyl itaconic acid, monoethyl itaconic acid, monobutyl itaconic acid, monooctyl itaconic acid, monomethyl fumarate, monoethyl fumarate, monobutyl fumarate, monooctyl fumarate, and monoethyl citraconate;

unsaturated dicarboxylic acid diester monomers such as dimethyl malate, dibutyl malate, dimethyl fumarate, dibutyl fumarate, dibutyl itaconate, and diperfluorocyclohexyl fumarate;

halogenated olefins such as vinylidene chloride, vinylidene fluoride, and chlorotrifluoroethylene; and

polyfunctional monomers such as ethylene glycol di(meth)acrylate, diethylene glycol di(meth)acrylate, triethylene glycol di(meth)acrylate, polyethylene glycol di(meth)acrylate, 1,4-butanediol di(meth)acrylate, 1,6-hexanediol di(meth)acrylate, neopentyl glycol di(meth)acrylate, 1,9-nonanediol di(meth)acrylate, 1,10-decanediol di(meth)acrylate, trimethylolpropane tri(meth)acrylate, pentaerythritol tetra(meth)acrylate, dipentaerythritol hexa(meth)acrylate, allyl methacrylate, triallyl cyanurate, diallyl maleate, and polypropylene glycol diallyl ether.

The macromonomer (d) contains the constituting unit (da) in an amount of 10% by mass or more in the total mass (100% by mass) of the macromonomer (d). When the amount is less than 10% by mass, the compatibility between the (meth)acrylic copolymer and the epoxy resin deteriorates, and there is a case wherein a macrophase-separated structure is formed and sufficient toughness and adhesive strength cannot be obtained in the epoxy resin composition and/or the cured product thereof of the present invention. The macromonomer (d) contains preferably 20% by mass or more of the constituting unit (da), more preferably 25% by mass or more, still more preferably 30% by mass or more, and most preferably 40% by mass or more.

The macromonomer (d) preferably contains 50% by mass or more of the constituting units derived from the (meth)acrylic monomer, and more preferably 70% by mass or more with respect to the total mass (100% by mass) of all the constituting units that constitute the macromonomer (d). The upper limit is not particularly limited and may be 100% by mass.

As the constituting unit derived from the (meth)acrylic monomer, a constituting unit in which R¹ in the formula (da) is a hydrogen atom or a methyl group and R² is COOR⁵ is preferable.

The macromonomer (d) is preferably compatible with the epoxy resin and the cured product thereof. Accordingly, the adhesive strength of the cured product of the epoxy resin composition is further improved.

Examples of the macromonomer compatible with the epoxy resin and the cured product thereof include polymethyl methacrylate. Further, in addition to the constituting unit derived from methyl methacrylate, it is more preferable that a constituting unit derived from a vinyl monomer having a polar functional group such as a carboxyl group, a hydroxyl group, an amide group, an amino group, and a cyclic ether group (glycidyl group (epoxy group), tetrahydrofurfuryl group, and the like) be further contained because the compatibility with the epoxy resin and the cured product thereof are further enhanced. Among these, a case wherein a constituting unit derived from a vinyl monomer having a glycidyl group is contained is particularly preferable because the compatibility with an epoxy resin is enhanced, reaction with a curing agent becomes easier, and the impact strength is excellent.

When the compatibility between the unit derived from the macromonomer (d) contained in the (meth)acrylic copolymer and the epoxy resin becomes higher than a certain level, the phase-separated size of the rubber-like segment (hereinafter, also referred to as “rubber part”), which is a polymer part consisting of the unit derived from the vinyl monomer (e) of the (meth)acrylic copolymer, becomes smaller, and a microphase-separated structure is achieved. Then, by adjusting the compatibility within a certain range, the microphase-separated structure can be controlled, and the characteristics of the epoxy resin composition and the cured product can be controlled.

Specifically, as the compatibility increases, the surface area of the rubber part becomes wider, and it becomes easier to form a micro lamellar structure, a micro linear structure, or a micro co-continuous structure. Furthermore, at the time of curing, the cyclic ether group reacts with the curing agent together with the epoxy resin to improve the interfacial strength between the epoxy resin and the rubber part, and the toughness and impact resistance of the cured product can be improved.

As the group having a cyclic ether, an organic group having a cyclic ether is preferable. As the organic group, an alkyl group, a cycloalkyl group, an aryl group, and a heterocyclic group are preferable. The heterocyclic group having a cyclic ether group may be a cyclic ether group itself or a heterocyclic group containing a cyclic ether structure in the ring. As the alkyl group, cycloalkyl group, aryl group, and heterocyclic group, the same groups as those described in R⁰′ and R⁷² of the general Formula (7) described later can be used. Further, two or more types of an alkyl group, a cycloalkyl group, an aryl group or a heterocyclic group may be linked. Furthermore, other substituents may also be contained within the range that does not significantly affect the effects of the present invention. As the substituent, the same group as that of the general Formula (7) described later can be used.

Examples of the cyclic ether group contained in the macromonomer (d) include an oxylanyl group, an oxetanyl group, an oxolanyl group, a dioxolanyl group, and a dioxanyl group. One or more of these can be appropriately selected and used.

Among these, an oxylanyl group, an oxetanyl group, and an oxolanyl group are preferable because the compatibility between the macromonomer (d) and the epoxy resin is easily improved.

Examples of the constituting unit having a cyclic ether group in the macromonomer (d) include a constituting unit derived from one or more monomers selected from a group consisting of glycidyl (meth)acrylate, (3,4-epoxycyclohexyl)methyl (meth)acrylate, β-methylglycidyl (meth)acrylate, (3-ethyloxetan-3-yl)methyl (meth)acrylate, tetrahydrofurfuryl (meth)acrylate, (2-methyl-2-ethyl-1,3-dioxolan-4-yl) (meth)acrylate, and (5-ethyl-1,3-dioxane-5-yl)methyl (meth)acrylate. The cyclic ether group may be bonded to an alkylene group.

Among these monomers, from the viewpoint that the compatibility between the macromonomer (d) and the epoxy resin is easily improved, glycidyl (meth)acrylate, (3,4-epoxycyclohexyl)methyl (meth)acrylate, β-methylglycidyl (meth)acrylate, (3-ethyloxetan-3-yl)methyl (meth)acrylate, and tetrahydrofurfuryl (meth)acrylate are preferable. Glycidyl (meth)acrylate, (3-ethyloxetan-3-yl)methyl (meth)acrylate, and tetrahydrofurfuryl (meth)acrylate, are more preferable. Glycidyl (meth)acrylate is still more preferable.

The macromonomer (d) may have a constituting unit (da) of 100% by mass or less, but preferably contains 90% by mass or less, and more preferably 80% by mass or less. By setting the content of the constituting unit (da) to be the upper limit value or less, the cyclic ether group is unlikely to cause a side reaction with the cyclic ether group or another functional group in the synthesis of the macromonomer (d), and the synthesis is easily performed.

As the macromonomer (d), a macromonomer in which a radically polymerizable group is introduced at the end of a main chain containing two or more constituting units (da) is preferable, and a macromonomer represented by the following Formula (1) is more preferable. When the epoxy resin composition contains a copolymer in which the macromonomer (d) is a macromonomer represented by Formula (1), the viscosity of the epoxy resin composition can further be reduced. At this time, as the copolymer, a copolymer in which the macromonomer (d) is a macromonomer other than the macromonomer represented by Formula (1) may further be contained.

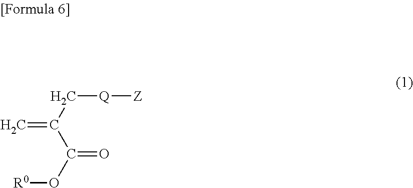

In the formula, R⁰ represents a hydrogen atom, a substituted or unsubstituted alkyl group, a substituted or unsubstituted alicyclic group, a substituted or unsubstituted aryl group, a substituted or unsubstituted heteroaryl group, a substituted or unsubstituted non-aromatic heterocyclic group, a substituted or unsubstituted aralkyl group, a substituted or unsubstituted alkaryl group, a substituted or unsubstituted organosilyl group, or a substituted or unsubstituted (poly)organosiloxane group, Q represents a main chain part including two or more constituting units represented by the above-described Formula (da), and Z represents an end group.

In Formula (1), R⁰ is the same as RP in CH₂═C (COOR⁰)—CH₂— described above, and the preferred aspect is also the same.

The two or more constituting units (da) contained in Q may be the same or different.

Q may consist of only the constituting unit (da), or may further contain constituting units other than the constituting unit (da).

As the constituting unit (da), Q preferably contains a constituting unit in which R¹ in the Formula (da) is a hydrogen atom or a methyl group and R² is COOR⁵. The proportion of the constituting units is preferably 50% by mass or more, and is more preferably 70% by mass or more, and may be 100% by mass with respect to the total mass (100% by mass) of all the constituting units that constitute Q.

The number of constituting units that constitute Q can be appropriately set in consideration of the number-average molecular weight and the like of the macromonomer (d).

Examples of Z include a hydrogen atom, a group derived from a radical polymerization initiator, a radically polymerizable group, and the like, similar to the end group of a polymer obtained by known radical polymerization.

As the macromonomer (d), a macromonomer represented by the following Formula (7) is particularly preferable.

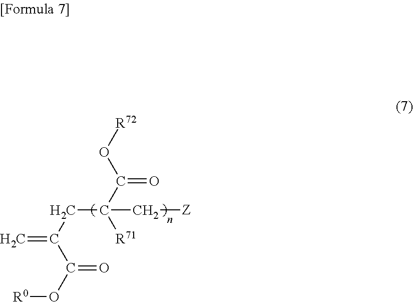

In Formula (7), Z is similar to Z in Formula (1).

In Formula (7), each group in R⁰ and R⁷² is the same as those described in R⁵ of COOR⁵. n is a natural number of 2 or more. n is preferably within the range wherein the number-average molecular weight (Mn) of the macromonomer (d) is 500 or more and 100,000 or less. The preferred range of the number-average molecular weight is as described below. The n R⁷¹ may be the same or different. The n R⁷² may be the same or different.

From the viewpoint of compatibility with epoxy resin, glass transition temperature of the macromonomer (d), and availability of the monomer, R⁰ and R⁷² preferably contain at least one selected from an alkyl group and a cycloalkyl group, and is more preferably contain an alkyl group.

R⁷¹ is independently a hydrogen atom or a methyl group, and a methyl group is preferable. In the macromonomer (d), from the viewpoint of ease of synthesis, it is preferable that more than half of R⁷¹ be a methyl group.

In other words, the macromonomer (d) contains a monomer unit having a group having a cyclic ether group represented by the general Formula (1). Hereinafter, this may be expressed as “the macromonomer (d) contains a monomer unit having a cyclic ether group”.

When the macromonomer (d) contains a monomer unit having a cyclic ether group, the compatibility between the macromonomer (d) unit contained in the (meth)acrylic copolymer and the epoxy resin is enhanced, and the curing is possible by reacting with a curing agent similar to the epoxy group of the epoxy resin. From the viewpoint of improving compatibility with the epoxy resin and easily reacting with the curing agent, R⁰ in the general Formula (1) is preferably a group having a cyclic ether group at the end.

When the compatibility between the unit derived from the macromonomer (d) contained in the (meth)acrylic copolymer and the epoxy resin becomes higher than a certain level, the phase-separated size of the rubber-like segment (hereinafter, abbreviated as “rubber part”), which is a polymer part consisting of the unit derived from the vinyl monomer (e) of the (meth)acrylic copolymer, becomes smaller, and a microphase-separated structure is achieved. Then, by adjusting the compatibility within a certain range, the microphase-separated structure can be controlled, and the characteristics of the epoxy resin composition and the cured product can be controlled.

Specifically, as the compatibility increases, the surface area of the rubber part becomes wider, and it becomes easier to form a micro lamellar structure, a micro linear structure, or a micro co-continuous structure. Furthermore, at the time of curing, the cyclic ether group reacts with the curing agent together with the epoxy resin to improve the interfacial strength between the epoxy resin and the rubber part, and the toughness and impact resistance of the cured product can be improved.

When the macromonomer (d) has the addition-reactive functional group and this macromonomer is added with the functional group of the polymer consisting of the constituting unit derived from the vinyl monomer (e), as the macromonomer (d), a macromonomer that contains one or more addition-reactive functional groups and two or more constituting units (da) described above is preferable. As the constituting unit (da), the same one as that in a case wherein the macromonomer (d) has a radically polymerizable group can be used.

In addition to the macromonomer (d), a compound having a functional group can be added to the functional group of a polymer consisting of a constituting unit derived from the vinyl monomer (e). Examples of compounds having a functional group include silicone compounds such as X-22-173BX (manufactured by Shin-Etsu Chemical Co., Ltd., product name), X-22-173DX (manufactured by Shin-Etsu Chemical Co., Ltd., product name), X-22-170BX (manufactured by Shin-Etsu Chemical Co., Ltd., product name), X-22-170DX (manufactured by Shin-Etsu Chemical Co., Ltd., product name), X-22-176DX (manufactured by Shin-Etsu Chemical Co., Ltd., product name), X-22-176F (manufactured by Shin-Etsu Chemical Co., Ltd., product name), and X-22-173GX-A (manufactured by Shin-Etsu Chemical Co., Ltd., product name).

The number-average molecular weight (Mn) of the macromonomer (d) is preferably 500 or more and 100,000 or less, more preferably 1,500 or more and 20,000 or less, and further preferably 2,000 or more and 10,000 or less. When the number-average molecular weight of the macromonomer (d) is the lower limit value or more in the above-described range, the compatibility between the (meth)acrylic copolymer and the epoxy resin is enhanced, a microphase-separated structure is formed in the epoxy resin composition and/or the cured product thereof, and sufficient toughness and adhesive strength are further improved. When the number-average molecular weight of the macromonomer (d) is the upper limit value or less in the above-described range, the (meth)acrylic copolymer and the vinyl monomer (e) are likely to be copolymerized, and the polymer consisting of only the vinyl monomer (e) is easily generated. Therefore, the microphase-separated structure can be easily controlled, the toughness and adhesive strength of the cured product can be improved, and the viscosity of the epoxy resin composition can further be reduced.

The number-average molecular weight of the macromonomer (d) is measured by gel permeation chromatography (GPC) using polystyrene as a reference resin.

The glass transition temperature of the macromonomer (d) (hereinafter, also referred to as “TgD”) is preferably 0° C. or higher and 150° C. or lower, more preferably 10° C. or higher and 120° C. or lower, and further preferably 30° C. or higher and 100° C. or lower. When TgD is the lower limit value or higher in the above-described range, the adhesive strength is further improved. When TgD is the upper limit value or lower in the above-described range, the viscosity of the epoxy resin composition can further be reduced.

TgD can be measured with a differential scanning calorimetry (DSC).

TgD can be adjusted by the composition or the like of the monomer that forms the macromonomer (d).

[Vinyl Monomer (e)]

The “vinyl monomer (e)” is a monomer that is not a macromonomer (d) and has an ethylenically unsaturated bond. The vinyl monomer (e) is not particularly limited, and the vinyl monomer which is the same as the monomer (d1) described for obtaining the macromonomer (d) can be used. The vinyl monomer (e) may be used alone, or two or more thereof may be used in combination.

It is preferable that at least a part of the vinyl monomer (e) be a (meth)acrylic monomer.

When the macromonomer (d) is added to the polymer consisting of the constituting unit derived from the vinyl monomer (e), it is suitable that the vinyl monomer (e) have a functional group capable of reacting with the functional group of the macromonomer (d).

The vinyl monomer (e) preferably contains an alkyl (meth)acrylate (hereinafter, also referred to as “monomer (e1)”) having an unsubstituted alkyl group having 1 to 30 carbon atoms. The carbon atoms of the alkyl (meth)acrylate are more preferably 2 to 30, and even more preferably 4 to 20. The monomer (e1) can impart excellent toughness to the cured product of the epoxy resin composition, and can exhibit excellent adhesive strength and impact strength.

Specific examples of the monomer (e1) include methyl (meth)acrylate, ethyl (meth)acrylate, n-propyl (meth)acrylate, n-butyl (meth)acrylate, 2-ethylhexyl (meth)acrylate, n-octyl (meth)acrylate, isooctyl (meth)acrylate, nonyl (meth)acrylate, isononyl (meth)acrylate, decyl (meth)acrylate, isodecyl (meth)acrylate, lauryl (meth)acrylate, hexadecyl (meth)acrylate, stearyl (meth)acrylate, isostearyl (meth)acrylate, behenyl (meth)acrylate, and branched nonyl acrylate (for example, product name Viscoat #197 manufactured by Osaka Organic Chemical Ind. Ltd.).

The vinyl monomer (e) may further contain a vinyl monomer other than the monomer (e1), when necessary. The other vinyl monomer can be appropriately selected from the monomers listed above.

Examples of preferred other vinyl monomers include (meth)acrylate, hydroxyethyl (meth)acrylate, hydroxypropyl (meth)acrylate, styrene, isobornyl (meth)acrylate, cyclohexyl (meth)acrylate, benzyl (meth)acrylate, tetrahydrofurfuryl (meth)acrylate, glycidyl (meth)acrylate, (meth)acrylamide, dimethyl (meth)acrylamide, and diethyl (meth)acrylamide.

In the copolymer, it is preferable that the composition of the constituting unit derived from the macromonomer (d) and the composition of the constituting unit derived from the vinyl monomer (e) be different. It is preferable that the vinyl monomer (e) have a composition that causes a difference in polarity between the polymer (hereinafter, also referred to as “polymer (e0)”) obtained by polymerizing only the vinyl monomer (e) and the macromonomer (d).

When the macromonomer (d) compatible with an epoxy resin and a cured product thereof is used, it is preferable that the composition of the vinyl monomer (e) be a composition in which the polymer (e0) has a lower polarity than that of the macromonomer (d).

As an example of the composition in which the difference in polarity occurs, an example is listed in which the macromonomer (d) contains a constituting unit derived from methyl methacrylate and the vinyl monomer (e) contains the monomer (e1) having 2 or more carbon atoms in the alkyl (meth)acrylate. In this case, since the alkyl group has more carbon atoms than the methyl group, the polarity is lower than that of the methyl methacrylate. With such a composition, a difference in polarity between the polymer (e0) and the macromonomer (d) is generated, and the polymer (e0) has a lower polarity than that of the macromonomer (d).

In this example, the proportion of the constituting units derived from methyl methacrylate to the total of all the constituting units that constitute the macromonomer (d) is preferably 20% by mass or more, and more preferably 50% by mass or more. The proportion of the monomer (e1) to the total amount of the vinyl monomer (e) is preferably 30% by mass or more, and more preferably 40% by mass or more. As the proportion of the constituting unit derived from methyl methacrylate in the macromonomer (d) increases, or as the proportion of the monomer (e1) in the vinyl monomer (e) increases, the difference in polarity between the polymer (e0) and the macromonomer (d) increases, and microphase separation is easy when the epoxy resin composition is cured.

Further, in this example, from the viewpoint of the increase of difference in polarity, the content of the vinyl monomer having a polar functional group such as a carboxyl group, a hydroxyl group, an amide group, an amino group, or an epoxy group in the vinyl monomer (e) is preferably 30% by mass or less, more preferably 10% by mass or less, and still more preferably 5% by mass or less with respect to the total amount of the vinyl monomer (e). The lower limit is not particularly limited and may be 0% by mass.

The vinyl monomer (e) has a glass transition temperature (TgE) of 25° C. or lower of the polymer (e0) obtained by polymerizing only the vinyl monomer (e). TgE is preferably −150° C. or higher and 0° C. or lower, and more preferably −150° C. or higher and −10° C. or lower. When TgE is within the above-described range, the polymer block of the vinyl monomer (e) has excellent flexibility, and thus, the toughness and adhesive strength of the cured product of the epoxy resin composition are further improved.

Here, TgE is the glass transition temperature of the homopolymer of the vinyl monomer when the vinyl monomer (e) is one type.

When there are a plurality of types of vinyl monomers (e), TgE means a value calculated by the Fox calculation formula from the glass transition temperature and mass fraction of each homopolymer of the plurality of types of vinyl monomers. The Fox calculation formula is the formula shown below, and TgE can be obtained by using a value described in [Polymer HandBook, J. Brandup, Interscience, 1989].

1/(273+TgE)=Σ(Wi/(273+Tgi))

In the formula, Wi indicates the mass fraction of a monomer i, and Tgi indicates glass transition temperature (° C.) of the homopolymer of the monomer i.

It is preferable that the above-described TgD and TgE have a relationship in the following Formula (3) from the viewpoint that the characteristics of the polymer chain derived from the macromonomer (d) and the polymer chain consisting of the constituting unit derived from the vinyl monomer (e) are sufficiently exhibited. In other words, it is preferable that TgD−TgE>0° C.

TgD>TgE (3)

More preferably, TgD−TgE>50° C., and most preferably TgD−TgE>80° C.

### [Content of Each Constituting Unit]

The content of the constituting unit derived from the macromonomer (d) in the copolymer is preferably 10% by mass or more and 90% by mass or less, and more preferably 20% by mass or more and 80% by mass or less, with respect to the total mass of all the constituting units that constitute the copolymer. When the content of the constituting unit derived from the macromonomer (d) is within the range, the compatibility between the (meth)acrylic copolymer and the epoxy resin becomes favorable, not macrophase-separated but suitable microlayer-separated structure is formed in the epoxy resin composition and/or the cured product thereof, and sufficient toughness and adhesive strength are further improved. Further, when the content of the constituting unit derived from the macromonomer (d) is the lower limit value or higher in the range, excessive compatibility between the copolymer and the epoxy resin is prevented, a suitable microphase-separated structure is formed, high toughness and adhesive strength can be easily obtained, and the process suitability and the degree of freedom of blending of the epoxy resin composition are further improved.

In the resin composition containing the macromonomer (d), the rubber-containing polymer, and the epoxy resin, and/or the cured product thereof, when the number of cyclic ether groups derived from the macromonomer (d) is 0.001×10⁻³ or more and 90.0×10⁻³ or less with respect to the total of 100 parts by mass of the rubber-containing polymer and the (meth)acrylic copolymer, it is preferable that the compatibility with the epoxy resin be favorable, the curing density be suitable, and the mechanical properties be excellent. The number of cyclic ether groups derived from the macromonomer (d) is more preferably 0.5×10⁻³ or more and 20.0×10⁻³ or less, and further preferably 0.7×10⁻³ or more and 18.0×10⁻³ or less.

The content of the constituting units derived from the vinyl monomer (e) in the copolymer is preferably 20% by mass or more and 90% by mass or less with respect to the total mass of all the constituting units that constitute the copolymer, and is more preferably 30% by mass or more and 80% by mass or less. When the content of the constituting unit derived from the vinyl monomer (e) is within the above-described range, the adhesive strength of the cured product of the epoxy resin composition is further improved.

### [Mass-Average Molecular Weight of (Meth)Acrylic Copolymer]

The mass-average molecular weight (Mw) of the copolymer is preferably 10,000 or more and 10 million or less, more preferably 20,000 or more and 900,000 or less, further preferably 30,000 or more and 800,000 or less, and most preferably 40,000 or more and 700,000 or less. When the mass-average molecular weight of the copolymer is the lower limit value or less in the above-described range, a microphase-separated structure is suitably formed in the epoxy resin composition and/or a cured product thereof, and the toughness and adhesive strength can be easily obtained. When the mass-average molecular weight of the copolymer is the upper limit value or less in the above-described range, the compatibility of the copolymer with the epoxy resin, the process suitability, and the degree of freedom of blending are further improved.

The mass-average molecular weight of the copolymer is a standard polystyrene-converted value measured by gel permeation chromatography (GPC). Specifically, the measurement is performed by the method described in Examples described later.

### [Method for Producing (Meth)Acrylic Copolymer]

Examples of the method for producing the copolymer include the following production methods (α) and (β). The copolymer may be produced by the production method (α) or may be produced by the production method (β). However, the method for producing the copolymer is not limited thereto.

Production method (α): A method of copolymerizing the macromonomer (d) and the vinyl monomer (e) by using the macromonomer having a radically polymerizable group as the macromonomer (d)

Production method (β): A method for causing the macromonomer (d) to react with a polymer consisting of a constituting unit derived from the vinyl monomer (e) containing a vinyl monomer having the functional group capable of reacting with the addition-reactive functional group, by using the macromonomer having the addition-reactive functional group as the macromonomer (d).

In these production methods, by adjusting the number-average molecular weight of the macromonomer (d), the composition of the monomer that constitutes the macromonomer (d), the composition of the vinyl monomer (e), or the like, the compatibility between the polymer chain derived from the macromonomer (d) and the polymer chain consisting of the constituting unit derived from the vinyl monomer (e) can be adjusted. For example, as described above, the difference in polarity between the macromonomer (d) and the polymer (e0) obtained by polymerizing only the vinyl monomer (e) affects the compatibility. As the difference in polarity increases, the compatibility decreases. As the compatibility decreases, there is a tendency that the microphase-separated structure is likely to be formed when the epoxy resin composition is cured.

As the macromonomer (d) and the vinyl monomer (e), those produced by a known method may be used, or commercially available ones may be used.

Examples of the method for producing the macromonomer (d) having a radically polymerizable group include a production method of using a cobalt chain transfer agent, a method of using an α-substituted unsaturated compound such as α-methylstyrene dimer as a chain transfer agent, a method of using an initiator, a method of chemically bonding a radically polymerizable group to a polymer, and a method of using thermal decomposition.

Among these, as a method for producing the macromonomer (d) having a radically polymerizable group, from the viewpoint that the number of production processes is small and the chain transfer constant of the catalyst used is high, the production method of using a cobalt chain transfer agent is preferable. The macromonomer (d) produced by using a cobalt chain transfer agent has a structure represented by the above-described Formula (1).

Examples of the method for producing the macromonomer (d) by using the cobalt chain transfer agent include a massive polymerization method, a solution polymerization method, and an aqueous dispersion polymerization method (suspension polymerization method, emulsion polymerization method, and the like). The aqueous dispersion polymerization method is preferable from the viewpoint that the recovery process is simple.

Examples of a method of chemically bonding a radically polymerizable group to a polymer include a production method in which the halogen group of the polymer having a halogen group is substituted with a compound having a radically polymerizable carbon-carbon double bond, a method of causing a vinyl monomer having an acid group to react with a vinyl polymer having an epoxy group, a method of causing a vinyl polymer having an epoxy group to react with a vinyl monomer having an acid group, and a method of causing a vinyl polymer having a hydroxyl group to react with a diisocyanate compound to obtain the vinyl polymer having an isocyanate group, and causing the vinyl monomer to react with the vinyl monomer having the vinyl polymer and a hydroxyl group, and any method may be used for production.

The number-average molecular weight of the macromonomer (d) can be adjusted with a polymerization initiator, a chain transfer agent, or the like.

Examples of the method for producing the macromonomer (d) having an addition-reactive functional group such as a hydroxyl group, an isocyanate group, an epoxy group, a carboxyl group, an acid anhydride group, an amino group, an amide group, a thiol group, and a carbodiimide group include a method of copolymerizing the vinyl monomer having a functional group, a method of using a chain transfer agent such as mercaptoethanol, mercaptoacetic acid, and mercaptopropionic acid. In addition, examples thereof include a method of using an initiator that can introduce a functional group such as 2,2′-azobis(propane-2-carboamidine), 4,4′-azobis(4-cyanovaleric acid), 2,2′-azobis[N-(2-carboxyethyl)-2-methylpropion amidine], 2,2′azobis[2[1(2hydroxyethyl)2imidazoline2yl]propane], and the like.

As a method for producing the copolymer, the production method (α) is preferable. In other words, the copolymer is preferably a copolymer of the macromonomer (d) and the vinyl monomer (e). In such a copolymer, the constituting unit derived from the macromonomer (d) and the constituting unit derived from the vinyl monomer (e) are randomly arranged. In other words, a polymer chain derived from one or more macromonomers (d) is bonded to the entire main chain of the copolymer. Such a polymer is preferable because the viscosity of the epoxy resin composition tends to be low when blended in the epoxy resin composition, for example, compared to a case wherein the constituting unit derived from the macromonomer (d) is bonded only to the end of the polymer chain consisting of the constituting unit derived from the vinyl monomer (e).

The composition of the monomer at the time of producing the copolymer, that is, the type of the monomer to be polymerized and the preferable range of the content (% by mass) (charged amount) of each monomer with respect to the total mass of all the monomers, is the same as the composition of the copolymer, that is, the type of the constituting unit derived from the monomers that constitute the copolymer and the content (% by mass) of each constituting unit with respect to the total mass of all the constituting units.

For example, the content of the macromonomer (d) with respect to the total mass (100% by mass) of all the monomers to be polymerized is preferably 10% by mass or more and 90% by mass or less, and more preferably 20% by mass or more and 80% by mass or less.

The polymerization of monomer may be performed by a known method using a known polymerization initiator. Examples of the known method include a method of causing the macromonomer (d) to react with the vinyl monomer (e) in the presence of a radical polymerization initiator at a reaction temperature of 60° C. or higher and 120° C. or lower for 1 hour or longer and 14 hours or shorter. At the time of polymerization, a chain transfer agent may be used when necessary.

As the polymerization method, for example, a known polymerization method such as a solution polymerization method, a suspension polymerization method, a massive polymerization method, and an emulsion polymerization method can be applied. The solution polymerization method is preferable from the viewpoint of productivity and film coating performance.

Solution polymerization can be carried out, for example, by supplying a polymerization solvent, a monomer, and a radical polymerization initiator into a polymerization vessel and holding these at a predetermined reaction temperature. The entire amount of the monomer may be charged in the polymerization vessel in advance (before the inside of the polymerization vessel is brought to a predetermined reaction temperature), or may be added dropwise after the inside of the polymerization vessel is brought to a predetermined reaction temperature, some of the monomer may be charged to the polymerization vessel in advance, and the remainder thereof may be added dropwise.

### (Epoxy Resin)

As the epoxy resin, any conventionally known epoxy resin can be used as long as the resin has at least two epoxy bonds in the molecule thereof, without limitation on the molecular structure, molecular weight, and the like.

Examples of the epoxy resin include bisphenol A type epoxy resin, bisphenol F type epoxy resin, bisphenol AD type epoxy resin, bisphenol E type epoxy resin, naphthalene type epoxy resin, biphenyl type epoxy resin, dicyclopentadiene type epoxy resin, phenol novolac type epoxy resin, alicyclic epoxy resin, and glycidylamine type epoxy resin. Further, examples thereof include modified epoxy resin such as urethane-modified epoxy resin, rubber-modified epoxy resin, and chelate-modified epoxy resin.

Examples of the epoxy resin include a prepolymer of the above-described epoxy resin, a copolymer of the above-described epoxy resin and another polymer, and a resin in which some of the above-described epoxy resin is substituted with a reactive diluent having an epoxy group.

Examples of the copolymer with other polymers include a polyether-modified epoxy resin and a silicone-modified epoxy resin.

Examples of the reactive diluent include monoglycidyl compound such as resorcin glycidyl ether, t-butylphenyl glycidyl ether, 2-ethylhexyl glycidyl ether, allyl glycidyl ether, phenyl glycidyl ether, 3-glycidoxypropyltrimethoxysilane, 3-glycidoxypropylmethyldimethoxysilane, 1-(3-glycidoxypropyl)-1,1,3,3,3-pentamethylsiloxane, and N-glycidyl-N,N-bis[3-(trimethoxysilyl)propyl]amine; and monoalicyclic epoxy compound such as 2-(3,4)-epoxycyclohexyl)ethyltrimethoxysilane. These epoxy resins may be used alone, or two or more thereof may be used in combination.

### (Curing Accelerator)

As the curing accelerator, known ones used as a thermocuring catalyst for epoxy resins can be used, and examples thereof include urea compound such as 3-(3,4-dichlorophenyl)-1,1-dimethylurea (DCMU); imidazole compound such as 2-methylimidazole and 2-ethyl-4-methylimidazole; adducts of imidazole compounds and epoxy resins; organic phosphorus compounds such as triphenylphosphine; borates such as tetraphenylphosphine tetraphenylborate; and diazabicycloundecene (DBU). One of these may be used alone, or two or more thereof may be used in combination.

### (Other Components)

Examples of other components that may be contained in the epoxy resin composition include antioxidants; mold release agents such as silicone oil, natural wax, and synthetic wax; powders such as glass beads, crystalline silica, fused silica, calcium silicate, and alumina; fibers such as glass fibers and carbon fibers; flame retardants such as antimony trioxide; halogen-trapping agents such as hydrotalcite and rare earth oxide; colorants such as carbon black and red iron oxide; silane coupling agents; defoaming agents; rheology modifiers; flame retardants; pigments; and dyes.

The epoxy resin composition preferably contains an antioxidant from the viewpoint of suppressing oxidative degradation of a rubbery polymer such as a butadiene rubber and obtaining further improved heat-resistant coloring properties.

As the antioxidant, a known antioxidant can be used, but from the viewpoint of antioxidant performance, at least one selected from a group consisting of phenol-based antioxidant, thioether-based antioxidant, and phosphite-based antioxidant is preferable, and at least one selected from a group consisting of phenol-based antioxidant and thioether-based antioxidant is more preferable.

Examples of the phenol-based antioxidant include dibutylhydroxytoluene, 1,1,3-tris(2-methyl-4-hydroxy-5-tert-butylphenyl)butane, 4,4′-butylidenebis(6-tert-butyl-m-cresol), 3-(3,5-di-tert-butyl4-hydroxyphenyl)stearyl propionate, pentaerythritol-tetrakis{3-(3,5-di-tert-butyl-4-hydroxyphenyl)propionate, and bis[3-(3-tert-butyl-4-hydroxy-5-methylphenyl)propionate][ethylene bis(oxyethylene)]. Of these, stearyl 3-(3,5-di-tert-butyl-4-hydroxyphenyl)propionate and pentaerythritol-tetrakis{3-(3,5-di-tert-butyl-4-hydroxyphenyl)propionate are preferable.

Examples of the thioether-based antioxidant include dilauryl-3,3′-thiodipropionic acid ester, ditridecyl-3,3′-thiodipropionic acid ester, dimyristyl-3,3′-thiodipropionic acid ester, distearyl-3,3′-thiodipropionic acid ester, laurylstearyl-3,3′-thiodipropionic acid ester, pentaerythritol tetrakis (3-laurylthiopropionate), bis[2-methyl-4-(3-laurylthiopropionyloxy)-5-tert-butylphenyl]sulfide, octadecyldisulfide, mercaptobenzimidazole, 2-mercapto-6-methylbenzimidazole, and 1,1′-thiobis(2-naphthol) (bis[3-(dodecylthio)propionate]2,2-bis[[3-(dodecylthio)-1-oxopropyloxy]methyl]-1,3-propanediyl). Of these, (bis[3-(dodecylthio)propionate]2,2-bis[[3-(dodecylthio)-1-oxopropyloxy]methyl]-1,3-propanediyl) is preferable.

Examples of the phosphite-based antioxidant include triphenylphosphite, trisnonylphenylphosphite, tris(2,4-di-tert-butylphenyl)phosphite, tridecylphosphite, trioctylphosphite, trioctadecylphosphite, didecylmonophenylphosphite, dioctylmonophenylphosphite, diisopropylmonophenylphosphite, monobutyldiphenylphosphite, monodecyldiphenylphosphite, monooctyldiphenylphosphite, bis(2,6-di-tert-butyl-4-methylphenyl)pentaerythritol diphosphite, 2,2-methylenebis(4,6-di-tert-butylphenyl)octylphosphite, bis(nonylphenyl)pentaerythritol diphosphite, bis(2,4)-di-tert-butylphenyl)pentaerythritolp diphosphite, and distearyl pentaerythritol diphosphite. Of these, trisnonylphenylphosphite, triphenylphosphite, tris(2,4-di-tert-butylphenyl)phosphite, bis(2,4)-di-tert-butylphenyl)pentaerythritolp diphosphite, and bis(2,6-di-tert-butyl-4-methylphenyl)pentaerythritol diphosphite are preferred, and tris(2,4-di-tert-butylphenyl)phosphite is more preferred.

### (Content Proportion of Each Component)

The content of the rubber-containing polymer in the epoxy resin composition is preferably 3 parts by mass or more and 50 parts by mass or less, and more preferably 5 parts by mass or more and 30 parts by mass or less, with respect to 100 parts by mass of the epoxy resin. When the content of the rubber-containing graft polymer is the lower limit value or more in the above-described range, the brittleness of the cured product of the epoxy resin composition is improved, and the adhesive strength is further improved. When the content of the rubber-containing graft polymer is the upper limit value or less in the above-described range, the adhesive strength is further improved without impairing the hardness of the cured product of the epoxy resin composition.

When the epoxy resin composition contains a curing accelerator, the content of the curing accelerator is preferably 1 part by mass or more and 20 parts by mass or less, and more preferably 2 parts by mass or more and 10 parts by mass or less, with respect to 100 parts by mass of the epoxy resin. When the content of the curing accelerator is the lower limit value or more in the above-described range, the curing rate is further improved. When the content of the curing accelerator is the upper limit value or less in the above-described range, the adhesive strength is further improved.

When the epoxy resin composition contains an antioxidant, the content of the antioxidant is preferably 0.0001 parts by mass or more and 10 parts by mass or less with respect to 100 parts by mass of the rubber-containing polymer. The lower limit amount is more preferably 0.001 parts by mass or more, and more preferably 0.01 parts by mass or more. The upper limit amount is more preferably 6 parts by mass or less, and more preferably 3 parts by mass or less. When the content of the antioxidant is the above-described lower limit value or less, the heat-resistant coloring properties tend to be further improved. Meanwhile, when the content of the antioxidant is the above-described upper limit value or more, it is possible to obtain a molded product having a favorable surface appearance by suppressing adhesion to the metal mold during injection molding.

### (Method for Producing Epoxy Resin Composition)

The method for producing the epoxy resin composition of the present invention is not particularly limited, and a known method can be used.

For example, the rubber-containing polymer, the epoxy resin, the curing accelerator when necessary, the (meth)acrylic copolymer, and other components may be mixed at the same time, some components (for example, the rubber-containing graft polymer and the epoxy resin) may be mixed in advance, and the mixture and the remaining components may be mixed. The mixing method is not particularly limited, and a rotation and revolution mixer, a mixing roll such as a triple roll, and a known mixer such as a kneader can be used.

An epoxy resin composition may be obtained by mixing the latex of the rubber-containing polymer and the epoxy resin and then removing the aqueous phase. The epoxy resin composition may be obtained by mixing the latex of the rubber-containing polymer, the epoxy resin, and the organic solvent and removing the aqueous phase and the organic phase.

When the epoxy resin composition contains an antioxidant, it is preferable that at least some of the antioxidant be added to the rubber-containing polymer before mixing with the epoxy resin.

The method of adding the antioxidant to the rubber-containing polymer is not particularly limited, but a method of adding the antioxidant as a powder or tablet having a particle size of several hundred μm, or in a state of being dispersed in water (dispersion), or the like can be employed. In the present invention, a method of adding an antioxidant to the rubber-containing polymer latex by dispersion is preferable. Further, it is preferable to recover the rubber-containing polymer as a powder from the rubber-containing polymer latex to which the antioxidant is added, as described above. Accordingly, a rubber-containing polymer to which an antioxidant is added can be obtained. By adding the antioxidant by dispersion, the antioxidant is close to the rubber-containing polymer and can be added more uniformly, and thus, the oxidative degradation of the rubbery polymer such as a butadiene rubber is suppressed and further improved heat-resistant coloring properties are obtained.

### <Curable Resin Composition>

The curable resin composition of the present invention contains the rubber-containing polymer, the epoxy resin, and the curing agent.

The curable resin composition of the present invention may further contain the (meth)acrylic copolymer, when necessary.

The curable resin composition of the present invention may further contain the curing accelerator, when necessary.

The curable resin composition of the present invention may further contain components other than the rubber-containing polymer, epoxy resin, curing agent, and curing accelerator, when necessary.

The rubber-containing polymer, the epoxy resin, the curing accelerator, the (meth)acrylic copolymer, and other components are as described above.

### (Curing Agent)

The curing agent cures the epoxy resin and is used to adjust the curability of the curable resin composition and the cured product properties.

As the curing agent, known curing agents for epoxy resin can be used, and examples thereof include acid anhydride, amine compound, phenol compound, and latent curing agent.

Examples of the acid anhydride include phthalic anhydride, methyltetrahydrophthalic anhydride, methylhexahydrophthalic anhydride, hexahydrophthalic anhydride, tetrahydro phthalic anhydride, trialkyltetrahydrophthalic anhydride, methylhymic anhydride, methylcyclohexene dicarboxylic acid anhydride, trimellitic acid anhydride, pyromellitic anhydride, benzophenone tetracarboxylic acid anhydride, ethylene glycol bistrimeritate, glycerol tristrimeritate, dodecenyl anhydride succinic acid, polyazelineic acid anhydride, and poly(ethyl octadecane diic acid) anhydride. Among these, methylhexahydrophthalic anhydride and hexahydrophthalic anhydride are preferable in applications wherein weather resistance, light resistance, heat resistance and the like are required. One of these may be used alone, or two or more thereof may be used in combination.

Examples of the amine compound include 2,5(2,6)-bis(aminomethyl)bicyclo[2,2,1]heptane, isophoronediamine, ethylenediamine, diethylenetriamine, triethylenetetramine, tetraethylenepentamine, diethylaminopropylamine, bis(4-amino-3-methyldicyclohexyl)methane, diaminodicyclohexylmethane, bis(aminomethyl)cyclohexane, bis(aminomethyl)norbornan, bis(4-aminocyclohexyl)methane, metaphenylenediamine, diaminodiphenylmethane, diaminodiphenylsulfone, diaminodiethyldiphenylmethane, diethyltoluenediamine, diaminodiphenyl sulfone (for example, 3,3′-diaminodiphenylsulfone(3,3′-DDS) and 4,4′-diaminodiphenylsulfone(4,4′-DDS), diaminodiphenyl ether (DADPE), bisaniline, dimethylaniline, triethylenediamine, dimethylbenzylamine, 2,4,6-tris(dimethylaminomethyl)phenol, benzyldimethylaniline, 3,3′-dichloro-4,4′-diaminodiphenylmethane (MOCA), 4,4′-diaminodiphenylmethane, 2,4′-diaminodiphenylmethane, 3,3′-diaminodiphenylmethane, 3,4′-diaminodiphenylmethane, 2,2′-diaminobiphenyl, 3,3′-diamino biphenyl, 2,4-diaminophenol, 2,5-diaminophenol, o-phenylenediamine, m-phenylenediamine, p-phenylenediamine, m-xylylene diamine, 2,3-tolylene diamine, 2,4-tolylene diamine, 2,5-tolylene diamine, 2,6-tolylene diamine, 3,4-tolylene diamine, methylthiotoluenediamine, diethyltoluenediamine, and dicyandiamide. One of these may be used alone, or two or more thereof may be used in combination.

Examples of the phenol compound include phenol novolac resin, cresol novolac resin, bisphenol A, bisphenol F, bisphenol AD, and derivatives of diallylized products of these bisphenols. One of these may be used alone, or two or more thereof may be used in combination.

The latent curing agent is a compound that is solid at room temperature and liquefies during heat curing of the epoxy resin composition to act as a curing agent.

Examples of the latent curing agent include organic acid hydrazide such as dicyandiamide, carbohydrazide, dihydrazide oxalate, dihydrazide malonate, dihydrazide succinate, dihydrazide iminodiacetate, adipic acid dihydrazide, pimelic acid dihydrazide, suberic acid dihydrazide, azelaic acid dihydrazide, dihydrazide sebacate, dodecane dihydrazide, hexadecane dihydrazide, dihydrazide maleate, dihydrazide fumarate, diglycolic acid dihydrazide, dihydrazide tartrate, dihydrazide malate, isophthalic acid dihydrazide, dihydrazide terephthalate, 2,6-naphthoic acid dihydrazide, 4,4′-bisbenzenedihydrazide, 1,4-naphthoic acid dihydrazide, Amicure VDH (product name, manufactured by Ajinomoto Co., Inc., registered trademark), Amicure UDH (product name, manufactured by Ajinomoto Co., Ltd., registered trademark), and trihydrazide citrate. One of these may be used alone, or two or more thereof may be used in combination.

### (Content Proportion of Each Component)

The content of the rubber-containing polymer in the curable resin composition is preferably 3 parts by mass or more and 50 parts by mass or less, and more preferably 5 parts by mass or more and 30 parts by mass or less, with respect to 100 parts by mass of the epoxy resin. When the content of the rubber-containing polymer is the lower limit value or more in the above-described range, the brittleness of the cured product of the curable resin composition is improved, and the adhesive strength is further improved. When the content of the rubber-containing polymer is the upper limit value or less in the above-described range, the adhesive strength is further improved without impairing the hardness of the cured product of the curable resin composition.

The content of the curing agent in the curable resin composition can be appropriately selected according to the type of the curing agent. For example, when the curing agent is dicyandiamide, the content is preferably 3 parts by mass or more and 20 parts by mass or less, and more preferably 3 parts by mass or more and 12 parts by mass or less, with respect to 100 parts by mass of the epoxy resin. When the content of the curing agent is the lower limit value or more in the above-described range, the adhesive strength after the curing is further improved. When the content of the curing agent is the upper limit value or less in the above-described range, the pot life of the curable resin composition is further improved.

When the curable resin composition contains a curing accelerator, the content of the curing accelerator is preferably 1 part by mass or more and 20 parts by mass or less, and more preferably 2 parts by mass or more and 10 parts by mass or less, with respect to 100 parts by mass of the epoxy resin. When the content of the curing accelerator is the lower limit value or more in the above-described range, the curing rate is further improved. When the content of the curing accelerator is the upper limit value or less in the above-described range, the adhesive strength is further improved.

When the curable resin composition contains an antioxidant, the content of the antioxidant is preferably 0.0001 parts by mass or more and 10 parts by mass or less with respect to 100 parts by mass of the rubber-containing polymer. The lower limit amount is more preferably 0.001 parts by mass or more, and more preferably 0.01 parts by mass or more. The upper limit amount is more preferably 6 parts by mass or less, and more preferably 3 parts by mass or less. When the content of the antioxidant is the above-described lower limit value or more, the heat-resistant coloring properties tend to be further improved. Meanwhile, when the content of the antioxidant is the above-described upper limit value or less, it is possible to obtain a molded product having a favorable surface appearance by suppressing adhesion to the metal mold during injection molding.

### (Method for Producing Curable Resin Composition)

The method for producing the curable resin composition of the present invention is not particularly limited, and a known method can be used.

For example, the rubber-containing polymer, the epoxy resin, the curing agent, the curing accelerator when necessary, and other components may be mixed at the same time, some components (for example, the rubber-containing polymer and the epoxy resin) may be mixed in advance, and the mixture and the remaining components may be mixed. The mixing method is not particularly limited, and a known mixer as described above can be used.

After mixing the latex of the rubber-containing polymer and the epoxy resin, by removing the aqueous phase, an epoxy resin composition is obtained. The epoxy resin composition, the curing agent, the additional epoxy resin when necessary, the curing accelerator, and other components may be mixed. By mixing the latex of the rubber-containing graft polymer, the epoxy resin, and the organic solvent and removing the aqueous phase and the organic phase, an epoxy resin composition is obtained. The epoxy resin composition, the curing agent, the additional epoxy resin when necessary, the curing accelerator, and other components may be mixed.

When the curable resin composition contains an antioxidant, it is preferable that at least some of the antioxidant be added to the rubber-containing polymer before mixing with the epoxy resin, as described above.

### (Application of Curable Resin Composition)

The curable resin composition of the present invention is useful as an adhesive because the rubber-containing polymer is well dispersed in the epoxy resin and a cured product having excellent impact resistance can be obtained.

Examples of the adhesive include adhesives for structures of vehicles such as automobiles, civil engineering and construction, electronic materials, general office work, medical use, and industrial use. Examples of the adhesive for electronic materials include adhesives for mounting such as interlayer adhesives for multilayer substrates such as build-up substrates, die bonding agents, adhesives for semiconductors such as underfills, underfill for BGA reinforcement, anisotropic conductive films (ACF), and anisotropic conductive pastes (ACP).

The curable resin composition of the present invention is useful as a modifier for molding materials because the rubber-containing polymer is well dispersed in the epoxy resin and a cured product having excellent impact resistance can be obtained.

Examples of the molding material include sheets, films, fiber-reinforced composite article (FRP) and the like. Examples of the application of the molding material include aircraft, automobiles, sports equipment, and wind turbines.

However, the application of the curable resin composition of the present invention is not limited to the description above, and the curable resin composition can also be used for other applications. For example, the curable resin composition can be used in various applications in which a thermosetting resin such as an epoxy resin is used. Examples of such applications include paint,s coating agents, insulating materials (including printed circuit boards and wire coatings), and sealants. Examples of the sealant include capacitor, transistor, diode, light-emitting diode, potting such as IC or LSI, dipping, transfer mold sealing, potting sealing such as IC and LSI type COB, COF, and TAB, underfill such as flip chip, and sealing (including reinforcing underfill) when mounting IC package such as QFP, BGA, and CSP.

### <Cured Product>

The cured product of the present invention is a cured product of the curable resin composition of the present invention.

The curing method is not particularly limited, and a conventionally adopted method for curing an epoxy resin composition can be used, and a thermosetting method is typically used.

Examples of the curing conditions for thermosetting the curable resin composition of the present invention include conditions of 160° C. or higher and 190° C. or lower for 20 minutes or longer and 30 minutes or shorter.

### EXAMPLE

Hereinafter, the present invention will be described in more detail with reference to Examples. However, the following Examples do not limit the scope of the present invention. In addition, “part” means “part by mass”.

### <Rubber Latex Production>

When the component (1) in Table 1 was charged in an autoclave having a capacity of 70 L, the temperature was raised, and the internal temperature reached 50° C., the redox-based initiator of the component (2) in Table 1 was added into the autoclave, and after starting the polymerization, the temperature was further raised to 60° C. and the reaction was carried out for 7 hours. Then, the component (3) and the component (4) in Table 1 were added dropwise over 8 hours. After completion of the dropwise addition, the internal temperature was raised to 80° C., the component (5) in Table 1 was added, and the mixture was reacted for 10 hours to obtain a latex (rubber latex) containing a butadiene rubbery polymer.

TABLE 1

| | Material | Parts |
|---|---|---|
| Component (1) | 1,3-butadiene | 19 |
| | Styrene | 1 |
| | t-dodecyl mercaptan | 0.1 |
| | Sodium alkyldiphenyl ether | 0.11 |
| | disulfonate (manufactured | |
| | by Kao Corporation, | |
| | Product name: PELEX SS-L) | |
| | Diisopropyl benzene | 0.3 |
| | hydroperoxide | |
| | Deionized water | 150 |
| Component (2) | Ferrous sulfate | 0.0005 |
| | Ethylenediaminetetraacetic | 0.0015 |
| | acid disodium | |
| | Sodium formaldehyde | 0.17 |
| | sulfoxylate | |
| | Deionized water | 10 |
| Component (3) | 1,3-butadiene | 76 |
| | Styrene | 4 |
| | t-dodecyl mercaptan | 0.4 |
| | Diisopropyl benzene | 0.4 |
| | hydroperoxide | |
| Component (4) | Sodium alkyldiphenyl ether | 1.3 |
| | disulfonate (manufactured | |
| | by Kao Corporation, | |
| | Product name: PELEX SS-L) | |
| | Sodium formaldehyde | 0.3 |
| | sulfoxylate | |
| | Deionized water | 10 |
| Component (5) | Diisopropyl benzene | 0.2 |
| | hydroperoxide | |

### Example 1

(Rubber-Containing Polymer Production)

In the reaction vessel, 80 parts of rubber latex was charged as a resin solid content and 0.2 parts of sodium alkyldiphenyl ether sulfonate was charged, the internal temperature was raised to 70° C., and then 0.3 parts of sodium formaldehyde sulfoxylate was added to an aqueous solution in which 10 parts of deionized water was dissolved. While maintaining the internal temperature at 70° C., a monomer mixture (mixture of monomers that form a vinyl monomer part) separately prepared with the composition shown in Table 2 was added dropwise over 120 minutes, and then the polymerization was performed by holding the monomer mixture for 60 minutes to obtain a rubber-containing polymer.

### (Volume-Average Particle Size of Rubber-Containing Polymer)

The volume-average particle size of the rubber-containing polymer latex was measured using a laser diffraction and scattering type particle size distribution measuring device (LA-960 manufactured by HORIBA).

### (Producing of Premix)

Epoxy resin, methyl ethyl ketone (MEK), and rubber-containing polymer were added to the reaction vessel, the mixture was heated at 90° C., MEK was continuously added, and azeotropic boiling was performed to remove water and MEK. Then, drying was performed under reduced pressure overnight at 50° C. to remove volatile components to obtain a mixture (premix) of the rubber-containing polymer and the epoxy resin.

### (Producing Curable Resin Composition)

In a mixing vessel, 13.6 parts of the prepared premix, 3.3 parts of dicyandiamide (Dicy) (manufactured by Mitsubishi Chemical Corporation), 1.6 parts of 3-(3,4-dichlorophenyl)-1,1-dimethylurea (DCMU, manufactured by Hodogaya Chemical Co., Ltd.), and 31.4 parts of epoxy resin (“jER828” manufactured by Mitsubishi Chemical Corporation, bisphenol A type epoxy resin) were mixed with Awatori Rentaro (manufactured by Shinky Co., Ltd.). After kneading the mixture with three rolls (manufactured by AIMEX), by adding 0.08 parts of the kneaded product and glass beads (“J-100”, manufactured by Potters Barotini) to the mixing vessel, and mixing using Awatori Rentaro, the curable resin composition was obtained.

The obtained curable resin composition was evaluated for peeling strength and impact resistance as follows. The results are shown in Table 2.

### (Peeling Strength)

By using a part from one end in the length direction to 50 mm on one side of a steel sheet (JIS G 3141, SPCC-SD, manufactured by Engineering Test Service Co., Ltd.) having a width of 25 mm, a length of 150 mm, and a thickness of 0.5 mm, as a gripping part, the curable resin composition was applied to the remaining part. Another steel sheet of the same size adhered to the surface coated with the curable resin composition was fixed such that the thickness of the curable resin composition layer was constant at 150 m, and was heated at 180° C. for 30 minutes, and the curable resin composition layer was cured to obtain a laminated body. The protrusion of the curable resin composition layer on the side surface of the laminated body was scraped off, and the gripping parts of each of the two steel sheets were bent outward at a right angle by 90° to obtain a T-shaped test piece.

The gripping part of the obtained test piece was held up and down with an Instron 5582 (Instron, load cell 1 kN), and the peeling strength was measured under the condition of 100 mm/min, and an average value of the peeling strength excluding the first 25 mm and the last 25 mm was obtained to evaluate the peeling strength in accordance with the following determination criteria.

“Determination Criteria”

++: The peeling strength is 100 N/25 mm or more.

+: The peeling strength is 60 N/25 mm or more and less than 100 N/25 mm.

−: The peeling strength is less than 60 N/25 mm.

### (Impact Resistance)

A symmetrical wedge test piece was prepared and evaluated in accordance with ISO11343 (JIS K 6865). A bent steel sheet with a thickness of 0.8 mm (JIS G 3141, SPCC-SD, manufactured by Engineering Test Service Co., Ltd.) was prepared. The prepared curable resin composition was applied to a part up to 30 mm, adhered to a bent steel sheet, and heated at 180° C. for 30 minutes, and the curable resin composition layer was cured to obtain a symmetrical wedge test piece.

The dynamic split resistance value was measured while driving a symmetrical wedge under the condition of 2 m/sec using a high-speed tensile tester Hydroshot HITS-T10 (manufactured by Shimadzu Corporation, load cell for 10 kN) and splitting a curable resin composition layer having a width of 20 mm and a length of 30 mm. Regarding the measured dynamic split resistance values, the average value of the dynamic split resistance values was calculated in the range excluding the first 25% and the last 10%, and the dynamic split resistance value was evaluated in accordance with the following determination criteria.

“Determination Criteria”

+++: The dynamic split resistance value is 0.3 kN/20 mm or more.

++: The dynamic split resistance value is 0.2 kN/20 mm or more and less than 0.3 kN/20 mm.

+: The dynamic split resistance value is 0.1 kN/20 mm or more and less than 0.2 kN/20 mm.

−: The dynamic split resistance value is less than 0.1 kN/20 mm.

### Examples 2 to 12, Comparative Examples 1 to 3

In the production of the rubber-containing polymer of Example 1, the same operation as that in Example 1 was performed except that the composition of the monomer mixture to be polymerized was changed as shown in Table 2 or Table 3. The evaluation results are shown in Tables 2 and 3.

TABLE 2

| | | | Example 1 | Example 2 | Example 3 | Example 4 | Example 5 | Example 6 | Example 7 |
|---|---|---|---|---|---|---|---|---|---|
| | Rubbery copolymner | Bd | 80 | 80 | 80 | 80 | 80 | 80 | 80 |
| | [parts by mass] | | | | | | | | |
| Monomoer | Monomer (c) | MMA | 18 | 17 | 13 | 15 | 11 | 11 | 8 |
| mixture | Monomer (b) | GMA | 1 | 1 | 2.5 | 1 | 1 | 5 | 5 |
| [parts by | | St | − | − | 2.5 | − | − | − | 5 |
| mass] | Other monomers | AMA | − | − | − | − | − | − | − |
| | Monomer (a) | 13BD | 1 | 2 | 2 | 4 | 8 | 4 | 2 |
| | Proportion in total | Monomer (b) | 5 | 5 | 25 | 5 | 5 | 25 | 50 |
| | mass of monomer | Monomer (a) | 5 | 10 | 10 | 20 | 40 | 20 | 10 |
| | mixture | | | | | | | | |
| | [% by mass] | | | | | | | | |
| | Volume-average particle size of | | 0.15 | 0.14 | 0.15 | 0.14 | 0.14 | 0.14 | 0.15 |
| | rubber-containing polymer [μm] | | | | | | | | |
| Evaluation | TPeel | Average value | 77.8 | 81.2 | 109.0 | 101.7 | 110.3 | 111.1 | 91.0 |
| | | [N/25 mm] | | | | | | | |
| | | Determination | + | + | ++ | ++ | ++ | ++ | + |
| | IWP | Average value | 0.19 | 0.19 | 0.46 | 0.40 | 0.42 | 0.34 | 0.23 |
| | | [kN/25 mm] | | | | | | | |
| | | Determination | + | + | +++ | +++ | +++ | +++ | ++ |

TABLE 3

| | | | | | | | | Compar- | Compar- | Compar- |
|---|---|---|---|---|---|---|---|---|---|---|
| | | | | | | | | ative | ative | ative |
| | | | Example | Example | Example | Example | Example | Example | Example | Example |
| | | | 8 | 9 | 10 | 11 | 12 | 1 | 2 | 3 |
| Rubbery copolymer | | Bd | 80 | 80 | 80 | 80 | 80 | 80 | 80 | 80 |
| [parts by mass] | | | | | | | | | | |
| Monomer | Monomer (c) | MMA | 13 | 16 | 11 | 13 | 13 | 20 | 19 | 18 |
| mixture | Monomer (b) | GMA | 5 | 1 | 2.5 | 2 | − | − | 1 | 1 |
| [parts by | | CYM100 | − | − | − | − | 3 | − | − | − |
| mass] | | St | − | 1 | 2.5 | 3 | 2 | − | − | − |
| | Other monomers | AMA | − | − | − | − | - | − | − | 1 |
| | Monomer (a) | 13BD | 2 | 2 | 4 | − | 2 | − | − | − |
| | | 16HX | − | − | − | 2 | - | − | − | − |
| Proportion in total mass of | | Monomer (b) | 25 | 10 | 25 | 25 | 25 | − | 5 | 5 |
| monomyer mixutre | | Monomer (a) | 10 | 10 | 20 | 10 | 10 | − | − | − |
| [% by mass] | | | | | | | | | | |
| Volume-average particle size of | | | 0.15 | 0.13 | 0.14 | 0.14 | 0.17 | 0.12 | 0.15 | 0.15 |
| rubber-containing polymer [μm] | | | | | | | | | | |
| Evaluation | TPeel | Average value | 60.8 | 97.6 | 113.3 | 113.4 | 104.9 | 21.4 | 65.5 | 79.1 |
| | | [N/25 mm] | | | | | | | | |
| | | Determination | + | + | ++ | ++ | ++ | − | + | + |
| | IWP | Average value | 0.21 | 0.23 | 0.26 | 0.42 | 0.12 | 0.07 | 0.06 | 0.01 |
| | | [kN/25 mm] | | | | | | | | |
| | | Determination | ++ | ++ | ++ | +++ | + | − | − | − |

The abbreviations in Table 2 and Table 3 have the following meanings.

Bd: Butadiene rubbery polymer

MMA: Methyl methacrylate

GMA: Glycidyl methacrylate

St: Styrene

AMA: Allyl methacrylate

13BD: 1,3-butanediol dimethacrylate

CYM100: Cyclomer 100 (Alicyclic epoxy group-containing methacrylate manufactured by Daicel)

16HX: 1,6-hexanediol dimethacrylate

TPeel: Evaluation result of peeling strength

IWP: Evaluation result of impact resistance (dynamic split resistance value)

In Table 2 and Table 3, the proportion (% by mass) of each of the monomer (a) and the monomer (b) to the total mass of the monomer mixture can be regarded as a proportion of each of the unit based on the monomer (a) and the unit based on the monomer (b) to the total mass of the vinyl monomer part.

The cured product of the curable resin composition of Examples 1 to 12 had excellent impact resistance. The cured product also had excellent peeling strength.

The cured product of the curable resin composition of Comparative example 1 using a rubber-containing polymer in which the vinyl monomer part did not contain the unit based on the monomer (a) and the unit based on the monomer (b), had inferior impact resistance and peeling strength.

The cured product of the curable resin composition of Comparative example 2 using a rubber-containing polymer in which the vinyl monomer part did not contain the unit based on the monomer (a), had inferior impact resistance.

The cured product of the curable resin composition of Comparative example 3 using a rubber-containing polymer in which the vinyl monomer part contained a unit based on AMA instead of the unit based on the monomer (a), had inferior impact resistance.

### Synthesis Examples 1 to 3, Comparative Synthesis Example 1

In producing the macromonomer (d), the same operation as that of the production method of the macromonomer (d) described in International Publication No. 2019-4995.1 was performed, except that the type and amount of monomer, chain transfer agent, and initiator were changed as shown in Table 4, to obtain macromonomers (d) of Synthesis examples 1 to 3 and Comparative synthesis example 1. The molecular weight of the obtained macromonomer is shown in Table 4.

TABLE 4

| | | | | | | | Comparative |
|---|---|---|---|---|---|---|---|
| | | | | Synthesis | Synthesis | Synthesis | Synthesis |
| | | | | example 1 | example 2 | example 3 | example 1 |
| Synthesis example of macromonomer (d) | | | | (a′-1) | (a′-2) | (a′-3) | (a′-4) |
| Charging | Monomer | Monomer which is | MMA | 50 | 75 | 75 | 95 |
| amount | | constituting unit expressed | MA | — | — | — | 5 |
| | | by Formula (da) | | | | | |
| | | (part by mass) | | | | | |
| | | Cyclic ether group- | GMA | 50 | 25 | 75 | — |
| | | containing monomer | | | | | |
| | | (part by mass) | | | | | |

| | | Total (part by mass) | 100 | 100 | 100 | 100 |
|---|---|---|---|---|---|---|
| | Chain | Chain transfer agent 1 | 0.004 | 0.001 | 0.002 | 0.005 |
| | transfer | (part by mass) | | | | |
| | agent | | | | | |
| | Initiator | PEROCTA O | 2.0 | 0.6 | 0.9 | 0.3 |
| | | (part by mass) | | | | |
| Molecular weight | | Number-average molecular | 3,500 | 5,400 | 13,000 | 20,100 |
| of macromonomer | | weight (Mn) | | | | |
| | | Mass-average molecular | 7,200 | 19,700 | 25,100 | 35,300 |
| | | weight (Mw) | | | | |

### Polymerization Examples 1 to 4, Comparative Polymerization Example 1

As shown in Table 5, the vinyl monomer (e) was polymerized on the macromonomer (d) of Synthesis examples 1 to 3 and Comparative synthesis example 1, and the (meth)acrylic copolymer of Polymerization examples 1 to 4 and Comparative polymerization example 1 was obtained.

TABLE 5

| | | | | | | | | Compar- |
|---|---|---|---|---|---|---|---|---|
| | | | | | | | | ative |
| | | | | Polymer- | Polymer- | Polymer- | Polymer- | Polymer- |
| | | | | ization | ization | ization | ization | ization |
| | | | | example 1 | example 2 | example 3 | example 4 | example 1 |
| Polymerization example of (meth)acrylic copolymer | | | | (A′-1) | (A′-2) | (A′-3) | (A′-4) | (a′-5) |
| Charging | Monomer | Macromonomer (d) | (a′-1) | 20 | 50 | — | — | — |
| amount | | (part by mass) | (a′-2) | — | — | 50 | — | — |
| | | | (a′-3) | — | — | — | 70 | — |
| | | | (a′-4) | — | — | — | — | 20 |
| | | Vinyl monomer (e) | BA | — | — | — | 30 | 80 |
| | | (part by mass) | 2EHA | 80 | 50 | — | — | — |
| | Initial charging agent | | Ethyl | 55 | 50 | — | — | 50 |
| | (part by mass) | | acetate | | | | | |
| | | | MEK | — | — | 50 | 50 | — |

| | | | | | | |
|---|---|---|---|---|---|---|
| Mass-average molecular amount | Mw | 14.5 | 3.7 | 21.5 | 10.3 | 48.9 |
| | (10,000) | | | | | |

### Blending Examples 1 to 11

The rubber-containing polymers obtained in Examples 1, 3, and 9 and the (meth)acrylic copolymers of Polymerization examples 1 to 4 and Comparative polymerization example 1 were blended in the amounts shown in Table 6, the peeling strength and the impact resistance were evaluated, and the evaluation results are shown in Table 6.

TABLE 6

| | | | Blend- | Blend- | Blend- | Blend- | Blend- | Blend- | Blend- | Blend- | Blend- | Blend- | Blend- |
|---|---|---|---|---|---|---|---|---|---|---|---|---|---|
| | | | ing | ing | ing | ing | ing | ing | ing | ing | ing | ing | ing |
| Rubber- | | Example 1 | − | − | − | − | − | − | 10 | − | − | − | − |
| containing | | Example 3 | 10 | 10 | 10 | 10 | 10 | 10 | − | − | − | 10 | 10 |
| polymer | | Example 9 | − | − | − | − | − | − | − | 10 | − | − | − |
| [part by | | | | | | | | | | | | | |
| mass] | | | | | | | | | | | | | |
| (Meth) | | Polymer- | 1 | 5 | − | − | − | − | − | − | − | − | − |
| acrylic | | ization | | | | | | | | | | | |
| copolymer | | example 1 | | | | | | | | | | | |
| [part by | | Polymer- | − | − | 1 | 5 | 10 | — | 1 | 1 | 10 | − | − |
| mass] | | ization | | | | | | | | | | | |
| | | example 2 | | | | | | | | | | | |
| | | Polymer- | − | − | − | − | − | 5 | − | − | − | − | − |
| | | ization | | | | | | | | | | | |
| | | example 3 | | | | | | | | | | | |
| | | Polymer- | − | − | − | − | − | − | − | − | − | 10 | − |
| | | ization | | | | | | | | | | | |
| | | example 5 | | | | | | | | | | | |
| | | Compar- | − | − | − | − | − | − | − | − | − | − | 1 |
| | | ative | | | | | | | | | | | |
| | | polymer- | | | | | | | | | | | |
| | | ization | | | | | | | | | | | |
| | | Number | 6.4 | 23.3 | 16.0 | 58.7 | 88.0 | 29.3 | 16.0 | 16.0 | 176.0 | 185.0 | 0.0 |
| | | of cyclic | | | | | | | | | | | |
| | | ether | | | | | | | | | | | |
| Eval- | TPeel | Average | 141 | 182 | 176 | 156 | 139 | 132 | 129 | 131 | 18 | 83 | 11 |
| uation | | value | | | | | | | | | | | |
| | | [N/25 mm] | | | | | | | | | | | |
| | | Determin- | ++ | ++ | ++ | ++ | ++ | ++ | ++ | ++ | − | + | − |
| | | ation | | | | | | | | | | | |
| | IWP | Average | 0.51 | 0.52 | 0.53 | 0.36 | 0.30 | 0.26 | 0.20 | 0.17 | 0.03 | 0.07 | <0.01 |
| | | value | | | | | | | | | | | |
| | | [kN/25 mm] | | | | | | | | | | | |
| | | Determin- | | | | | | | | | | | |
| | | ation | +++ | +++ | +++ | +++ | +++ | ++ | ++ | + | − | − | − |

The abbreviations in Table 6 have the following meanings.

TPeel: Evaluation result of peeling strength

IWP: Evaluation result of impact resistance (dynamic split resistance value)

### INDUSTRIAL APPLICABILITY

According to the epoxy resin composition and the curable resin composition of the present invention, the rubber-containing polymer is well dispersed in the epoxy resin, and a cured product having excellent impact resistance can be obtained.

In the cured product of the present invention, the rubber-containing polymer is well dispersed in the epoxy resin and the cured product has excellent impact resistance.

1. An epoxy resin composition, comprising:
a rubber-containing polymer, and
an epoxy resin, wherein
the rubber-containing polymer contains at least one rubbery polymer and at least one vinyl monomer part, and
the vinyl monomer part has a unit based on a monomer (a) described below, a unit based on a monomer (b) described below, and a unit based on a monomer (c) described below, wherein
the monomer (a) is a polyfunctional (meth)acrylate, the monomer (b) is at least one monomer selected from a group consisting of epoxy group-containing (meth)acrylates and aromatic vinyl monomers, and the monomer (c) is an alkyl (meth)acrylate.

2. The epoxy resin composition according to claim 1, wherein
the rubbery polymer is at least one selected from a group consisting of a diene rubber, a diene-acrylic composite rubber, an acrylic rubber, a silicone rubber, and an acrylic-silicone composite rubber.

3. The epoxy resin composition according to claim 1, wherein
a proportion of the unit based on the monomer (a) is 1% by mass or more and 45% by mass or less, and a proportion of the unit based on the monomer (b) is 1% by mass or more and 50% by mass or less, with respect to a total mass of the vinyl monomer part.

4. A curable resin composition, comprising:
a rubber-containing polymer,
an epoxy resin, and
a curing agent, wherein
the rubber-containing polymer contains at least one rubbery polymer and at least one vinyl monomer part, and
the vinyl monomer part has a unit based on a monomer (a) described below, a unit based on a monomer (b) described below, and a unit based on a monomer (c) described below, wherein
the monomer (a) is a polyfunctional (meth)acrylate, the monomer (b) is at least one monomer selected from a group consisting of epoxy group-containing (meth)acrylates and aromatic vinyl monomers, and the monomer (c) is an alkyl (meth)acrylate.

5. The curable resin composition according to claim 4, wherein
the rubbery polymer is at least one selected from a group consisting of a diene rubber, a diene-acrylic composite rubber, an acrylic rubber, a silicone rubber, and an acrylic-silicone composite rubber.

6. The curable resin composition according to claim 4, wherein
a proportion of the unit based on the monomer (a) is 1% by mass or more and 45% by mass or less, and a proportion of the unit based on the monomer (b) is 1% by mass or more and 50% by mass or less, with respect to a total mass of the vinyl monomer part.

7. A cured product of the curable resin composition according to claim 4.

8. An epoxy resin composition, comprising:
a rubber-containing polymer,
an epoxy resin, and
a (meth)acrylic copolymer, wherein
the (meth)acrylic copolymer has a constituting unit derived from a macromonomer (d) and a constituting unit derived from a vinyl monomer (e),
a glass transition temperature (TgE) of a polymer obtained by polymerizing only the vinyl monomer (e) is 25 degrees or less,
the rubber-containing polymer contains at least one rubbery polymer and at least one vinyl monomer part, and
the vinyl monomer part has a unit based on a monomer (a) described below, a unit based on a monomer (b) described below, and a unit based on a monomer (c) described below, wherein
the monomer (a) is a polyfunctional (meth)acrylate, the monomer (b) is at least one monomer selected from a group consisting of epoxy group-containing (meth)acrylates and aromatic vinyl monomers, and the monomer (c) is an alkyl (meth)acrylate.

9. The epoxy resin composition according to claim 8, wherein
a number-average molecular weight of the macromonomer (d) is 500 or more and 100,000 or less.

10. The epoxy resin composition according to claim 8, wherein
the content of the constituting unit derived from the macromonomer (d) in the (meth)acrylic copolymer is 10% by mass or more and 90% by mass or less with respect to the total mass of all the constituting units of the (meth)acrylic copolymer.

11. The epoxy resin composition according to claim 8, wherein
the macromonomer (d) has a radically polymerizable group and has two or more constituting units represented by Formula (da) described below: 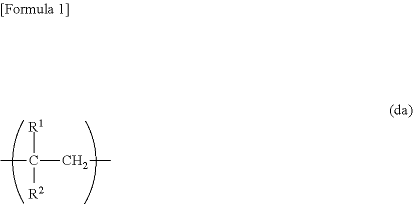
in the formula, R¹ represents a hydrogen atom, a methyl group, or CH₂OH, R² represents OR³, a halogen atom, COR⁴, COOR⁵, CN, CONR⁶R⁷, NHCOR⁸, or R⁹;
R³ to R⁸ independently represent a hydrogen atom, a substituted or unsubstituted alkyl group, a substituted or unsubstituted alicyclic group, a substituted or unsubstituted aryl group, a substituted or unsubstituted heteroaryl group, a substituted or unsubstituted non-aromatic heterocyclic group, a substituted or unsubstituted aralkyl group, a substituted or unsubstituted alkaryl group, a substituted or unsubstituted organosilyl group, or a substituted or unsubstituted (poly)organosiloxane group; the substituents that substitute these groups are at least one selected from a group consisting of an alkyl group, an aryl group, a heteroaryl group, a non-aromatic heterocyclic group, an aralkyl group, an alkaryl group, a carboxylic acid group, a carboxylic acid ester group, an epoxy group, a hydroxy group, an alkoxy group, a primary amino group, a secondary amino group, a tertiary amino group, an isocyanato group, a sulfonic acid group, and a halogen atom;
R⁹ represents a substituted or unsubstituted aryl group, a substituted or unsubstituted heteroaryl group or a substituted or unsubstituted non-aromatic heterocyclic group; the substituents that substitute these groups are at least one selected from a group consisting of an alkyl group, an aryl group, a heteroaryl group, a non-aromatic heterocyclic group, an aralkyl group, an alkaryl group, a carboxylic acid group, a carboxylic acid ester group, an epoxy group, a hydroxy group, an alkoxy group, a primary amino group, a secondary amino group, a tertiary amino group, an isocyanato group, a sulfonic acid group, a substituted or unsubstituted olefin group, and a halogen atom.

12. The epoxy resin composition according to claim 11, wherein
the macromonomer (d) is a macromonomer represented by Formula (1) described below: 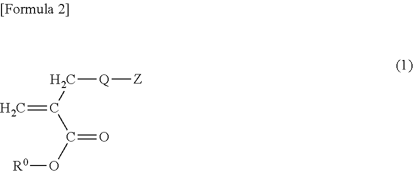
in the formula, R⁰ represents a hydrogen atom, a substituted or unsubstituted alkyl group, a substituted or unsubstituted alicyclic group, a substituted or unsubstituted aryl group, a substituted or unsubstituted heteroaryl group, a substituted or unsubstituted non-aromatic heterocyclic group, a substituted or unsubstituted aralkyl group, a substituted or unsubstituted alkaryl group, a substituted or unsubstituted organosilyl group, or a substituted or unsubstituted (poly)organosiloxane group, Q represents a main chain part including two or more constituting units represented by the above-described Formula (da), and Z represents an end group.

13. The epoxy resin composition according to claim 8, wherein
the macromonomer (d) contains a constituting unit having a cyclic ether group.

14. The epoxy resin composition according to claim 13, wherein
the constituting unit having a cyclic ether group is contained in an amount of 10% by mass or more and 100% by mass or less with respect to the total mass of the constituting unit derived from the macromonomer (d).

15. The epoxy resin composition according to claim 13, wherein
the number of the contained cyclic ether groups derived from the macromonomer (d) is 0.001×10⁻³ or more and 90.0×10⁻³ or less with respect to a total mass of 100 parts by mass of the rubber-containing polymer and the (meth)acrylic copolymer.

16. The epoxy resin composition according to claim 13, wherein
the cyclic ether group derived from the macromonomer (d) is one or more selected from a group consisting of an oxiranyl group, an oxetanyl group, an oxolanyl group, a dioxolanyl group, and a dioxanyl group.

17. The epoxy resin composition according to claim 8, wherein
the macromonomer (d) has a constituting unit derived from one or more monomers selected from a group consisting of glycidyl (meth)acrylate, (3,4-epoxycyclohexyl)methyl (meth)acrylate, β-methylglycidyl (meth)acrylate, (3-ethyloxetan-3-yl)methyl (meth)acrylate, tetrahydrofurfuryl (meth)acrylate, (2-methyl-2-ethyl-1,3-dioxolan-4-yl) (meth)acrylate, and (5-ethyl-1,3-dioxane-5-yl)methyl (meth)acrylate.

18. The epoxy resin composition according to claim 8, wherein
the rubbery polymer is at least one selected from a group consisting of a diene rubber, a diene-acrylic composite rubber, an acrylic rubber, a silicone rubber, and an acrylic-silicone composite rubber.

19. The epoxy resin composition according to claim 8, wherein
a proportion of the unit based on the monomer (a) is 1% by mass or more and 45% by mass or less, and a proportion of the unit based on the monomer (b) is 1% by mass or more and 50% by mass or less, with respect to a total mass of the vinyl monomer part.

20. A curable resin composition, comprising:
the epoxy resin composition according to claim 8; and
a curing agent.

21. An adhesive, comprising:
the epoxy resin composition according to claim 8 or the curable resin composition according to claim 20.

22. A molding material, comprising:
the epoxy resin composition according to claim 8 or the curable resin composition according to claim 20.

23. A cured product, comprising:
the epoxy resin composition according to claim 8 or the curable resin composition according to claim 20.
